(19) United States
(12) Patent Application Publication
(10) Pub. No.: US 2025/0253945 A1
(43) Pub. Date: Aug. 7, 2025

(54) K-space Detector and K-space Detection Methods

(71) Applicant: Phase Sensitive Innovations, Inc., Newark, DE (US)

(72) Inventors: Garrett Schneider, New Castle, DE (US); Janusz Murakowski, Bear, DE (US); Christopher Schuetz, Avondale, PA (US); Shouyuan Shi, Newark, DE (US); William L. Beardell, Bethesda, MD (US)

(21) Appl. No.: 19/044,301

(22) Filed: Feb. 3, 2025

Related U.S. Application Data
(60) Provisional application No. 63/548,696, filed on Feb. 1, 2024.

(51) Int. Cl. H04B 10/079; G01S 3/04; H04B 10/40

(52) U.S. Cl. CPC H04B 10/07953; G01S 3/043; H04B 10/40; H04B 2210/006; H04B 2210/07

(57) ABSTRACT

An imaging receiver comprising an antenna array to receive RF signals from at least one RF source, a plurality of electro-optic modulators to modulate an optical carrier with a received RF signal to generate modulated optical signals, a first and second set of optical fibers configured to transmit the modulated optical signals into an interference region to cause interference among the modulated optical signals to generate optical signal interference; a lens to perform a Fourier transform of the optical signal interference to spatial positions on an image plane, a photodetector array to record the optical signal interference on the image plane, and a processor to computationally reconstruct the at least one RF source in k-space from the recorded optical signal interference. The optical fibers included in the first set of optical fibers have varying lengths, and the optical fibers included in the second set of optical have the same length.

### CROSS-REFERENCE TO RELATED APPLICATION

This application claims priority from U.S. Patent App. Ser. No. 63/548,696 filed Feb. 1, 2024, the entire disclosure of which is hereby incorporated by reference.

### BACKGROUND

Provisions for future wireless networks are driven by the need for ever-increasing data rates. To address this, emerging wireless networks are increasing their carrier frequencies to the millimeter-wave (mmW) regime, where the hardware requirements in terms of cost, size, weight and power (C-SWAP) to perform the digital beam-forming process become quite demanding. Digital beamforming, along with digital beamspace processing techniques such as BLAST and MUSIC, allow for angle-of-arrival (AoA) and frequency determination and are extensively implemented in the field. However, digital beamforming techniques generally rely upon recording of high-frequency signals, implemented through high-speed analog-to-digital converters (ADCs). To handle today's broadband data streams, these ADCs have become quite expensive and power-hungry; techniques such as front-end downconversion reduce the required sample rates while introducing local oscillator (LO) synchronization error. Further, performing direction-finding and frequency measurement requires either matrix inversions or fast Fourier transforms, with both operations becoming increasingly complex as array size increases. Additional techniques such as RF lenses alleviate the computational cost of the beamforming step, but are bulky due to their necessary RF wavelength-scale footprint, and can be lossy depending upon the material system. Array windowing or subarray processing offers a reduction in the number of recorded data streams, albeit by creating a trade-space of complexity versus beamforming capability.

Optical beamforming addresses many of these concerns by moving the beamforming process to a free-space optical processor, in which an optical lens performs an analog Fourier transform of a scaled version of the RF phase front incident upon the antenna array. This operation is performed at the speed of light, with detection performed by either a charge-coupled device (CCD) camera, or, in the presence of a coherent optical local oscillator, by photodetectors, which may be high-speed for high signal data rates. Previous investigations have demonstrated instantaneous angle-angle and angle-frequency RF source localization, while three-dimensional imaging has, to this point, been implemented through complex algebraic reconstruction algorithms and a tomographic approach, requiring a library of resolvable RF source coordinates in angle-angle-frequency space, with size determined by the product of the field-of-view (FOV) and operating bandwidth divided by spatio-temporal resolution. This reconstruction technique becomes prohibitively complex for wideband, high-resolution systems, and therefore may take advantage of similar compressive sensing techniques to those used in digital beamforming.

The need for fast and accurate channel identification and RF source location has grown due to the opening of mmW spectrum for 5G ultrawideband (5G UWB) communication networks, which has grown to include wideband imaging systems.

### SUMMARY

An imaging receiver comprising an antenna array including a plurality of antenna elements configured to receive RF signals from at least one RF source; a plurality of electro-optic modulators corresponding to the plurality of antenna elements, each modulator configured to modulate an optical carrier with a received RF signal to generate modulated optical signals; a first set of optical fibers respectively coupled to the plurality of antenna elements via the electro-optic modulators and a second set of optical fibers respectively coupled to the plurality of antenna elements via the electro-optic modulators, the first set of optical fibers and the second set of optical fibers configured to transmit the modulated optical signals into an interference region to cause interference among the modulated optical signals to generate optical signal interference; a lens provided in the interference region and configured to perform a Fourier transform of the optical signal interference to spatial positions on an image plane; a photodetector array, including a plurality of photodetectors, configured to record the optical signal interference on the image plane; and a processor configured to computationally reconstruct the at least one RF source in k-space from the recorded optical signal interference. The optical fibers included in the first set of optical fibers have varying lengths, and the optical fibers included in the second set of optical have the same length.

A method of RF signal processing comprising receiving, at an antenna array including a plurality of antenna elements, RF signals from at least one RF source; modulating the received RF signals from each of the plurality of antenna elements onto an optical carrier to generate modulated optical signals; transmitting, along a first set of optical fibers and a second set of optical fibers, the modulated optical signals into an interference region to cause interference among the modulated optical signals to generate optical signal interference; performing a Fourier transform of the optical signal interference to spatial positions on an image plane; recording the optical signal interference on the image plane using a photodetector array including a plurality of photodetectors; and reconstructing the at least one RF source in k-space from the recorded optical signal interference. The optical fibers included in the first set of optical fibers have varying lengths, and the optical fibers included in the second set of optical have the same length.

### BRIEF DESCRIPTION OF THE DRAWINGS

The above and other objects, features, and advantages of the inventive concept will become more apparent to those skilled in the art upon consideration of the following detailed description with reference to the accompanying drawings.

FIG. 1 is an illustration of an imaging receiver in accordance with aspects of the invention;

FIG. 2 is a simplified and partial view of the imaging receiver in accordance with aspects of the invention;

FIGS. 3A and 3B illustrate examples of fiber length distribution of the imaging receiver in accordance with aspects of the invention;

FIG. 3C illustrates an example of three different fiber profiles in accordance with aspects of the invention;

FIG. 3D illustrates a comparative plot of the three different fiber profiles in accordance with aspects of the invention;

FIGS. 4A, 4B, and 4C illustrate plots of contours of ambiguity in 2D k-space in accordance with aspects of the invention;

FIGS. 5A, 5B, and 5C illustrate photodetector maps for 2D k-space in accordance with aspects of the invention;

FIGS. 6A, 6B, and 6C illustrate a k-space scene corresponding to each of three different temporal projections in accordance with aspects of the invention;

FIGS. 7A and 7B illustrate a combination of projections in accordance with aspects of the invention;

FIGS. 8A, 8B, and 8C illustrate a combination of projections with a weighting coefficient in accordance with aspects of the invention;

FIGS. 9A, 9B, and 9C illustrate a combination of projections using a tapered aperture

FIGS. 10A and 10B illustrate scenes in 2D k-space in accordance with aspects of the invention;

FIGS. 11A and 11B illustrates the scene from FIGS. 10A and 10B with a combination of an additional projection in accordance with aspects of the invention;

FIG. 12 is an illustration of an imaging receiver in accordance with aspects of the invention;

FIG. 13A illustrates an antenna array arrangement in accordance with aspects of the invention;

FIG. 13B illustrates a point-spread function (PSF) plot of the antenna arrangement illustrated in FIG. 13A in accordance with aspects of the invention;

FIGS. 14A, 14B, and 14C illustrate the relationship between the photodetector array data space and the source coordinate space in accordance with aspects of the invention;

FIGS. 15A and 15B illustrate an experimental setup of spatially positioned RF sources in accordance with aspects of the invention;

FIG. 16A illustrates an antenna array arrangement in accordance with aspects of the invention;

FIG. 16B illustrates a plot of fiber lengths corresponding to the antenna arrangement illustrated in FIG. 16A in accordance with aspects of the invention;

FIG. 17 illustrates a flow diagram for experimental validation of 3D source location in accordance with aspects of the invention; and

FIGS. 18A, 18B, and 18C illustrate PSF plots for separate test cases and different fiber profiles in accordance with aspects of the invention.

### DETAILED DESCRIPTION OF EXEMPLARY EMBODIMENTS

Various aspects of the inventive concept will be described more fully hereinafter with reference to the accompanying drawings.

The herein described subject matter and associated exemplary implementations are directed to improvements and extensions of an imaging receiver as described in U.S. Pat. Nos. 7,965,435, 8,159,737, 8,848,752, 9,525,489, 10,009,098, and 11,855,692 the disclosures of each being hereby incorporated by reference in their entireties.

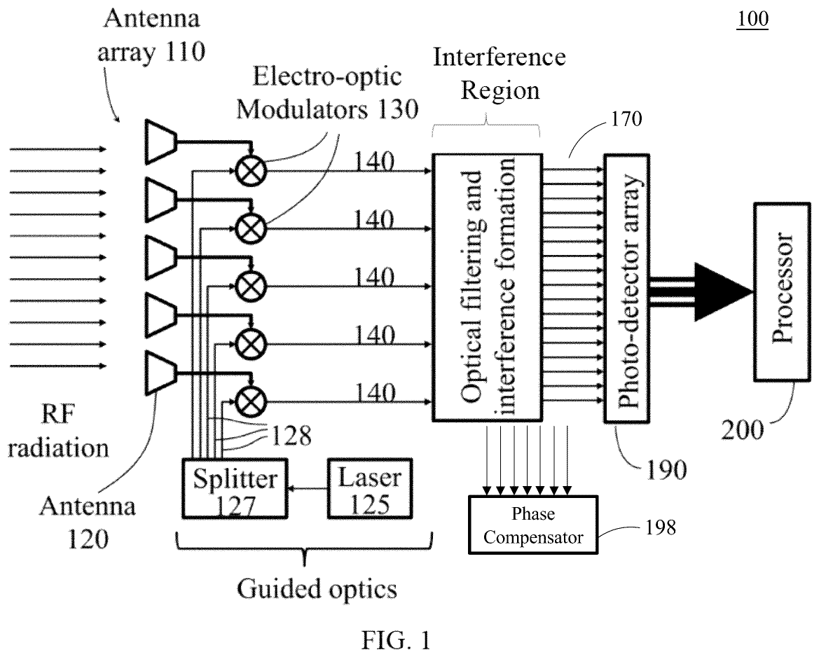

An imaging receiver 100 (i.e., k-space imager) in accordance with aspects of the invention is depicted in FIG. 1. The illustrated imaging receiver 100 is a phased-array receiver. The imaging receiver 100 includes a processor 200 coupled to the various other components within the receiver to implement the functionality described herein. The processor 200 may be a general purpose processor (e.g., part of a general purpose computer, such as a PC) or dedicated processor (e.g., digital signal processor (DSP), FPGA (field programmable gate array)). The processor 200 may be configured with software to control the components of the imaging receiver 100. Variations of suitable processors for use in the imaging receiver 100 will be understood by one of skill in the art from the description herein.

An antenna array 110, including a plurality of N antenna elements 120, receives RF signals from an external RF source (e.g., RF emitters). While the antenna elements 120 shown are horn antennae, those of ordinary skill in the art will understand that a variety of antenna means may be used. RF signals sampled at the antenna elements 120 are used to modulate a laser beam (i.e., optical carrier beam), emitted by laser 125, and split M ways via a splitter 127. An electro-optic (EO) modulator 130 (e.g., a lithium niobate phase modulator) is coupled to each of the antenna elements 120 and receives a branch of the split laser beam that it uses to convert the RF energy received at each antenna element 120 to the optical domain. The electro-optic (EO) modulator 130 does so by modulating the optical carrier beam produced by the laser 125. The laser 125 may operate, for example, at a frequency Φₒ between 1550 and 1560 nm. As detailed in U.S. Pat. No. 9,525,489, the time-variant modulation manifests itself in the frequency domain as a set of sidebands flanking the original carrier frequency (or wavelength), at which the laser 125 operates. As a result, the energy radiated in the RF domain appears in the optical domain as sidebands of the original carrier frequency. This optical up-conversion of the RF signal into optical domain may be coherent so that all the phase and amplitude information present in RF signal is preserved in the optical sidebands. This property of coherence preservation in the optical up-conversion allows the recovery of the RF-signal angle of arrival using optical means.

As further detailed in U.S. Pat. No. 9,525,489, the modulated optical beams containing the laser carrier wavelength and the sidebands with imprinted RF signal (i.e., up-converted modulated optical beams) are conveyed by waveguides 140 (e.g., optical fibers) and brought into a fiber output array 160 (e.g., fiber bundle) that forms an array to re-launch the up-converted RF signals back into an interference region 170 where they re-form the exact beams that were incident on the front-end antenna array as a composite optical beam (i.e., “optical signal interference”). The interference region 170 may include interference space (e.g., air, vacuum, a gas other than air, or a liquid) or a solid (e.g., a slab waveguide, such as in a photonic integrated circuit (PIC)). Additionally, the interference region 170 may include optical components, such as beam splitters, lenses, filters, polarizers, waveplates, etc. As discussed in further detail below, the optical components include a biconvex spherical lens 181 (e.g., Fourier lens), which performs optically a spatial Fourier transform of the input field. The interference region 170 provides for optical filtering (through the optical components) and interference (through the interference space) which allows the up-converted modulated optical beams emanating from the optical fiber output array 160 to interfere with each other in the interference space to thereby form a composite optical beam (i.e., “optical signal interference”), which is subsequently detected and recorded by a photodetector array 190 (e.g., photodetector array, image sensor (e.g., charged coupled device (CCD) sensor), etc.). Re-forming of the RF beams in the optical domain is possible due to the spatially coherent up-conversion process, which, as discussed above, preserves not only the amplitude and phase of the RF signal at each antenna element 120, but also the phase relations between the antenna elements 120. The photodetector array 190 may be an array of light sensitive elements (e.g., photo-detectors, high-speed photodiodes, CCD pixels) such as those of a CCD or contact image sensor or CMOS image sensor. In some exemplary implementations, to extract or recover information encoded in the RF signals input by the antenna elements 120, the composite optical beam output may be further split with additional beam-splitters and combined with reference laser beams for heterodyne detection by a high speed photodetector (see, e.g., U.S. Pat. No. 10,009,098). The output of the photodetector array 190 may be processed by processor 200 in order to computationally reconstruct the RF sources of the RF-signal in k-space.

### Linear Antenna Array

Antenna array 110 may be a linear (i.e., one dimensional (1D)) antenna array 110, including a plurality of N antenna elements 120. As a non-limiting example, the following discussion will be based on a 32-element linear antenna array (i.e., N=32) wherein the 32 antenna elements are arranged along a single axis.

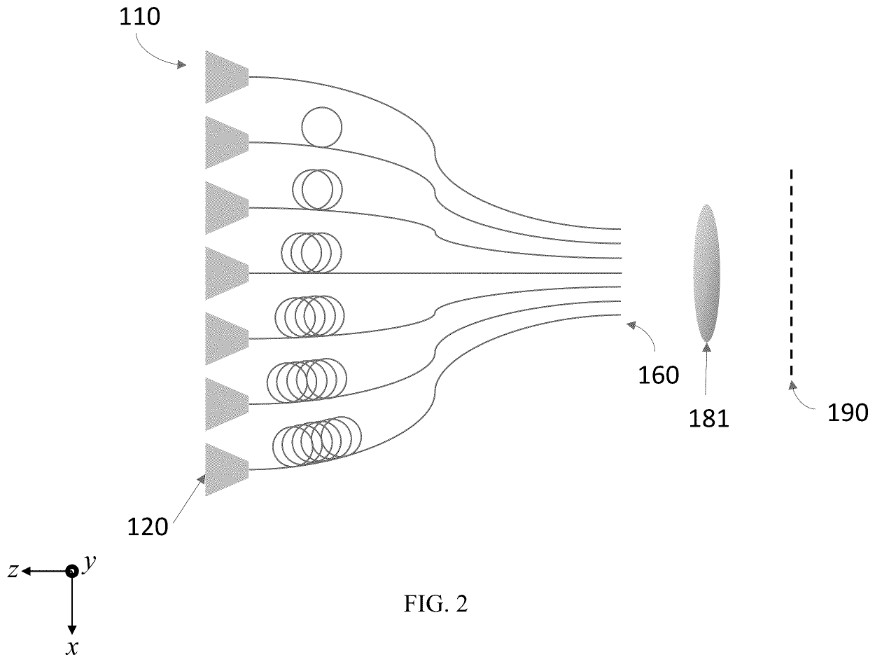

FIG. 2 illustrates a simplified and partial view of the imaging receiver 100 that is configured to generate a k-space perspective (e.g., projection) of an RF scene (i.e., three-dimensional (3D) to two-dimensional (2D) mapping of the RF scene), and in which the antenna array 110 is arranged as a linear antenna array and corresponding optical fibers 140 propagating to form fiber output array 160.

As illustrated in FIG. 2, each of the individual optical fibers 140 has a different fiber length. Among the optical fibers 140, the difference between the longest optical fiber and the shortest optical fiber is referred to herein as the “temporal aperture.” Just as the aperture size (spatial) relative to the wavelength determines the angular resolution of an antenna array, so does the temporal aperture determine the frequency resolution of the k-space sensor. For example, the larger the temporal aperture, the narrower the frequency separation between resolvable RF sources. In opposition to this is the fixed number of antenna elements 120 that divides the temporal aperture size to set the temporal element spacing; just as the antenna element pitch in a phased array determines the existence and spacing of grating lobes, likewise in the frequency domain, the temporal element spacing determines the alias-free frequency range, i.e., the free spectral range (FSR), of the imaging receiver 100. Boresight-aligned RF sources separated by integer multiples of the FSR will produce identical responses and are thus indistinguishable.

In consideration of the above, one design goal of the fiber length distribution of the optical fibers 140 may be to match the FSR of the temporal array to the operational bandwidth of the system, which is set by the front-end RF components. The front-end RF components may refer to any of the components connected upstream of the electro-optic modulators 130. For example, the front-end RF components may include the antenna element 120 and one or more RF amplifiers (not illustrated). For discussion purposes, in a non-limiting example, the operational bandwidth of the imaging receiver 100 may be one of 10-25 GHz or 20-45 GHz. In the former case, the FSR should be equal to or slightly greater than 15 GHZ, and in the latter case 25 GHz.

Alternatively, the FSR of the temporal array may be chosen based on the desired intermediate frequency (IF) bandwidth that is resolved in separate beams by the temporal aperture. For example, with 32 resolved beams, and a desired IF channelization BW of 1 GHZ, the FSR would be set to be 32 GHz. The frequency resolution may be defined as the FSR divided by the number of antenna elements (e.g., N=32). Table 1 below indicates the time aperture sizes corresponding to various FSRs, and the resulting frequency resolution for N=32.

TABLE 1

| | | | |
|---|---|---|---|
| | | Temporal | Lₘₐₓ − |
| FSR | Resolution | Aperture (mm) | Lₘᵢₙ |

| (GHz) | (GHz) | in fiber | free space | (mm) |
|---|---|---|---|---|
| 50 | 1.5625 | 129.64 | 191.88 | 125.59 |
| 32 | 1 | 202.56 | 299.79 | 196.23 |
| 28 | 0.875 | 231.50 | 342.62 | 224.27 |
| 24 | 0.75 | 294.64 | 436.07 | 285.43 |
| 20 | 0.625 | 324.10 | 479.67 | 313.97 |
| 16 | 0.5 | 405.13 | 599.59 | 392.47 |

As an example, the different fiber length profiles may be implemented through a fiber arrayed waveguide grating (FAWG). The relative time delay in each optical fiber 140 may be linearly proportional to the vertical position of each antenna element 120 within the antenna array 110, which results in a temporal array that is also aperiodic.

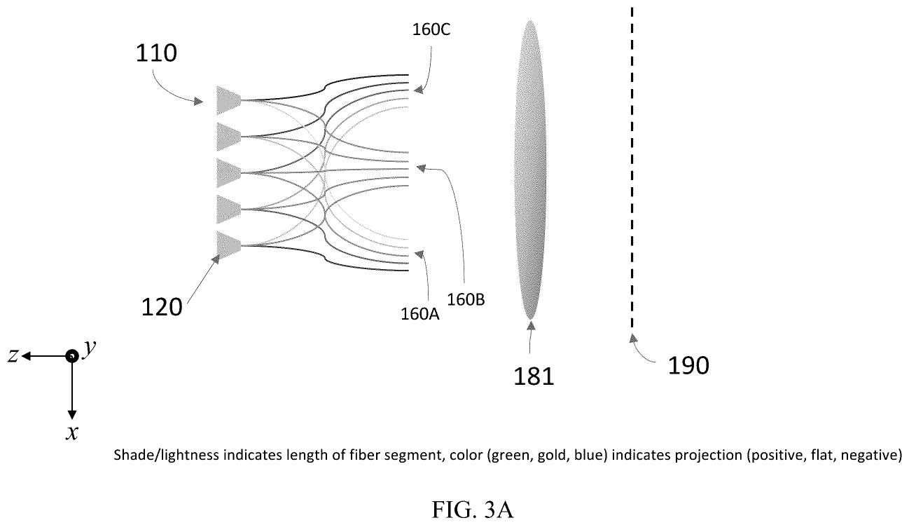

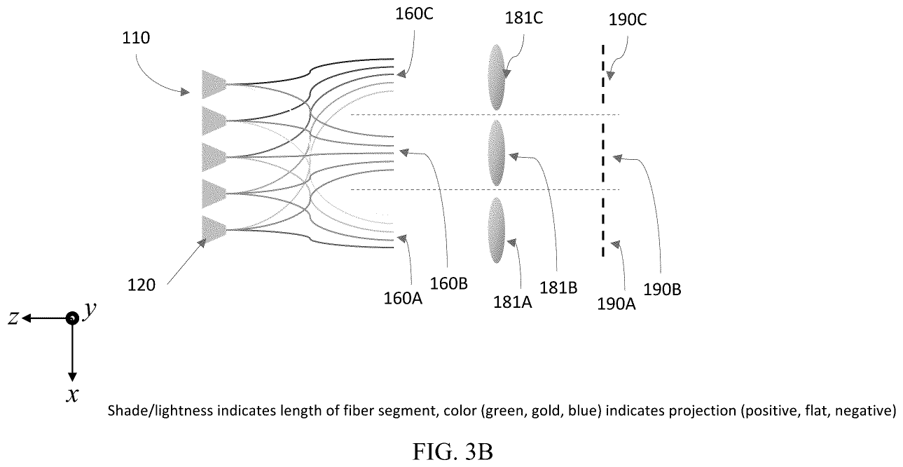

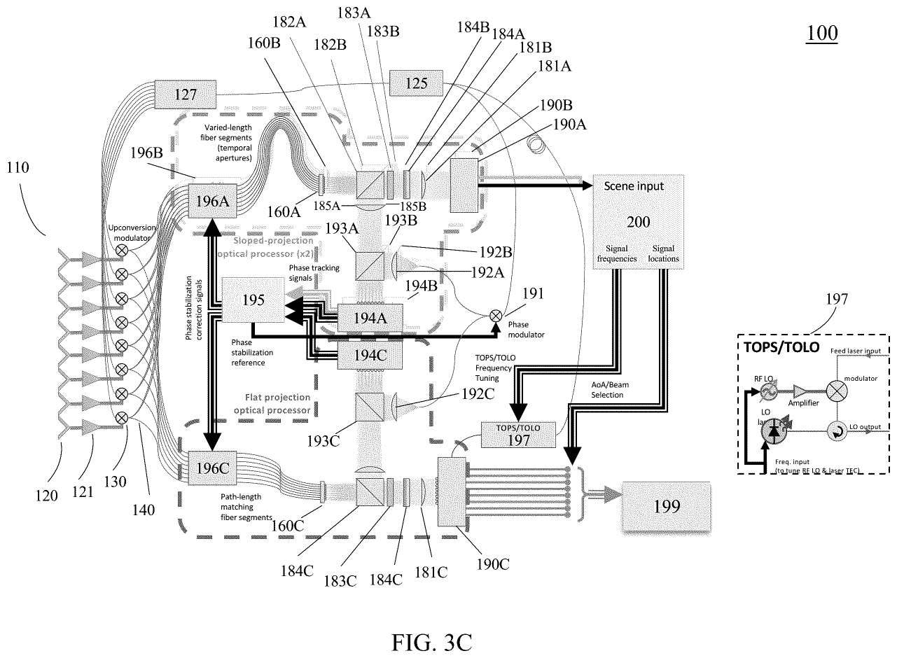

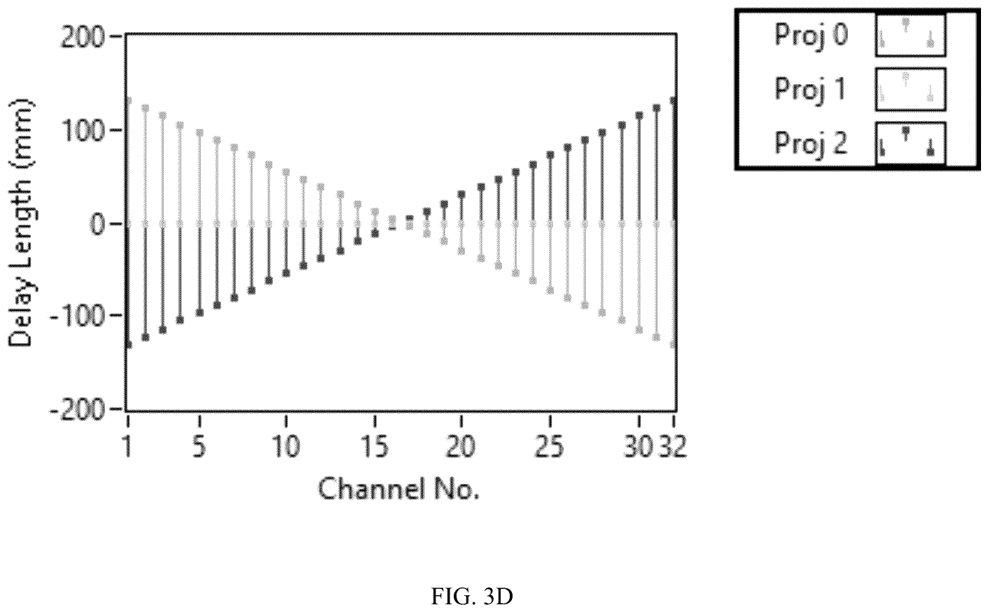

In accordance with one embodiment, the fiber length distribution of the imaging receiver 100 may be grouped into three separate fiber length profiles as illustrated in FIGS. 3A and 3B. For example, as illustrated in FIGS. 3A and 3B, the fiber length distribution of the imaging receiver 100 may include a first fiber length profile and a third fiber length profile wherein the first fiber length profile and the third fiber length profile are identical except for the sign of the slope. The fiber length distribution of the imaging receiver 100 may include a second fiber length profile wherein all fiber lengths (i.e., channel lengths) are equal in length (i.e., “flat profile”). The first fiber length profile may have a positive slope and may be brought into a brought into a first fiber output array 160A. The second fiber length profile may be flat (0 slope) and may be brought into may be brought into a brought into a second fiber output array 160B. The third fiber length profile may have a negative slope and may be brought into a third fiber output array 160C.

As illustrated in FIG. 3A, one biconvex spherical lens 181 and one photodetector array 190 may be shared among the different projections. Although not illustrated in FIG. 3A, switches may be utilized to switch among the three separate fiber length profiles. For example, a 1×3 optical switch (e.g., a Micro-Electro-Mechanical System (MEMS) switch, a magneto-optical switch) may be installed subsequent to each antenna element 120. The photodetector array 190 may be synchronized with the switching among the three separate fiber length profiles to capture each corresponding k-space projection (or simply “projection”).

As illustrated in FIG. 3B, separate biconvex spherical lenses 181A, 181B, and 181C and corresponding separate photodetector arrays 190A, 190B, and 190C may be provided for the three separate fiber length profiles and the resulting three projections.

FIG. 3C illustrates an example of the imaging receiver 100 that includes multiple photodetector arrays 190A, 190B, and 190C, each corresponding to the projections from the different fiber length profiles. For example, FIG. 3C illustrates an example of three different fiber profiles configured to generated three projections of an RF scene. The three different fiber profiles may include one flat profile and two sloped profiles discussed in further detail below. As illustrated in FIG. 3C, the output of each antenna element 120 may feed a low-noise amplifier 121, which in turn drives the RF input of the electro-optic modulator 130, thereby upconverting the sampled RF field to an optical field. The output of the optical field from the electro-optic modulators 130 are propagated through the different fiber length profiles resulting in an optical field that is a scaled version of the RF field being launched into the interference region 170.

FIG. 3C includes example interference region optics 180 and other components. The interference region optics may include biconvex spherical lens 181A-181C, polarizing beam-splitters 182A-182C, quarter-wave plates 183A-183C, and filters 184A-184C. For the sake of brevity, and where applicable, the interference region optics 180 and other components will be discussed with respect to only one of the respective different fiber length profiles. The modulated optical signals (e.g., the optical field) output from the fiber output array 160A (160B, 160C) may pass through a polarizing beam-splitter 182A (182B, 18C) and a quarter-wave plate 183A (183B, 18C), at which point the polarization is changed from linear to circular. Following the quarter-wave plate 183A (183B, 183C), a filter 184A (184B, 184C) (e.g., a series of Dense Wavelength Division Multiplexing (DWDM) filters) reflects the optical carrier from each fiber 140, after which point the quarter-wave plate 183A (183B, 18C) turns the circular polarization into a wave polarized linearly and orthogonal to the original input. The modulated optical signals (e.g., the optical field) output from the fiber output array 160A (160B, 160C) may also be directed by the polarizing beam-splitter 182A (182B, 18C) to a separate arm via a first lens 185A (185B, 185C) for overlay with a common reference of swept phase laser 125 via phase modulator 191, second lens 192A (192B, 192C), and beam splitter 193A (193B, 193C) to determine phase perturbations via phase control detectors 194A (194B, 194C) incurred through propagation along the optical fiber 140. Based on the determined phase perturbations, phase controller 195 may compensate for the determined phase perturbations via a 1×N phase shifter 196A (196B, 196C). This active-feedback process ensures that the optical signals across the fibers 140 remain spatially coherent, which allows for the biconvex spherical lens 181 (e.g., Fourier lens) to perform spatial processing on all the received RF signals. Phase compensator 198 may include phase modulator 191, second lens 192A (192B, 192C), and beam splitter 193A (193B, 193C), phase control detectors 194A (194B, 194C), phase controller 195, and 1×N phase shifter 196A (196B, 196C). Further details regarding the determining of phase perturbations and the compensation for the determined phase perturbations within the imaging receiver 100 is provided in U.S. Pat. Nos. 7,965,435 and 8,159,737.

At the other output of the polarizing beam-splitter 182A (182B, 18C), the filter 184A (184B, 184C) allows the RF sidebands upon the optical carrier to continue on to the biconvex spherical lens 181A (181B, 181C) of focal length f, which performs optically a spatial Fourier transform of the input field. The resulting image is then sampled by photodetector array 190A (190B, 190C), thereby allowing optical imaging of the RF beamspace. As discussed in further detail below, through the optical imaging of the RF beamspace, peak detection, k-space reconstruction, waveform/data recovery may be performed by processor 200. In an embodiment, analog to digital converters 199 may be provided to perform waveform/data recovery.

The distribution of coherence across the antenna array 110 may be further simplified through the use of a tunable optical paired source (TOPS) and a tunable optical local oscillator (TOLO) that enable optical generation of high-purity, widely tunable RF carriers and their modulation with baseband signals. Further details regarding the tunable sources are provided in U.S. Pat. Nos. 9,525,489, 8,848,752.

Although the imaging receiver 100 illustrated in FIG. 3C includes three separate photodetector arrays 190A-190C, aspects of the invention are not limited to such an embodiment. For example, as discussed above, one photodetector array may be shared among the different projections via switching. In addition, subsets of photodetector arrays 190 that is sufficiently large in size may be shared among a subset of the projections. For example, in an embodiment as shown in FIG. 3A, one photodetector array 190 may be shared for three projections. For example, in another embodiment, two photodetector arrays 190 may be shared for three projections. In such an embodiment, a first photodetector array 190 may be utilized for the flat projection, and a second photodetector array may be utilized for the two sloped projections. Moreover, in such an embodiment, each of the two sloped projections may have separate interference region optics (i.e., separate assembly of interference region optics), but the output images of each of the two sloped projections are directed to separate halves (e.g., the left and right halves) of the second photodetector array.

As illustrated in FIG. 3D, the lengths of each of the fibers within the first fiber length profile (e.g., first sloped fiber profile) are plotted as the difference between each fiber length and the corresponding fiber length within the second fiber length profile. Similarly, the lengths of each of the fibers within the third fiber length profile (e.g., second sloped profile) are plotted as the difference between each fiber length and the corresponding fiber length within the second fiber length profile. As used herein, a “temporal projection” refers to a k-space perspective (i.e., projection) captured by imaging receiver 100 using one particular fiber length profile. As such, in this embodiment imaging receiver 100 captures three temporal projections. For example, the imaging receiver 100 captures a first temporal projection (i.e., projection 0) corresponding to the first fiber length profile, a second temporal projection (i.e., projection 1) corresponding to the second fiber length profile, and a third temporal projection (i.e., projection 2) corresponding to the third fiber length profile.

In the antenna array 110, each antenna element 120 receives the same signal apart from a time delay arising from each antenna element's location in the antenna array 110 and the AoA. For a given frequency, this time delay corresponds to a per-antenna 120 phase shift given by

$${Φ}_{i} = k \cdot {x}_{i} = ( 2 π / c ) f [ sin ( α ) cos ( ε ) {x}_{i} + sin ( ε ) {y}_{i} ] \qquad ( Equation 1 )$$

In equation 1, xᵢ=xᵢ\hat{x}+yᵢŷ represents the location of antenna element i in the antenna array 120, k is the RF wavevector with magnitude k=(2π/c)f, corresponding to the RF signal with frequency f, and a and s are respectively the azimuth and elevation angles comprising the signal's AoA, and c is the speed of light. In a 1D antenna array 110 as discussed in this example, yᵢ=0, and assuming that all RF sources are located in the horizontal plane, ε≈0, and thereby set cos(ε)=1. Therefore, in the 1D antenna array 110 as discussed, AoA a=the azimuth angle.

A challenge for simultaneous direction finding and frequency identification in broadband phased-array receivers is the ambiguity that arises from the frequency dependence of the phases imparted by AoA: when the frequency is unknown, the true AoA cannot be directly inferred from the phases as evidenced by Equation 1. To resolve this ambiguity, the present application discloses the use of the additional, known, per-antenna element time delays imparted by the fiber delay lengths (e.g., the fiber length profiles discussed above). By comparing the response of the imaging receiver 100 to the same scene as obtained with multiple time-delay profiles (e.g., projections 0, 1, and 2), both frequency and AoA can be determined.

In the imaging receiver 100, the image (optical reconstruction of the RF waves (e.g., by photodetector array 190)) is informally described as a map of the incident RF power as a function of AoA. However, as noted above, this is not strictly true, especially for broadband receivers. Instead, the image is a map of the power as function of the total phase, where the phase has contributions arising from both the spatial antenna distribution and the delay lengths, where those from former are dependent on both AoA and frequency, while those from the latter are dependent on frequency only. In the standard case of a flat projection (i.e., second temporal projection (projection 1) having equal path lengths of the optical fibers 140 corresponding to each antenna element 120 (i.e., receiver channel)), the phase is proportional to the projection of the wavevector onto the aperture (i.e., effective area) of each antenna 120, as in Equation 1. However, when a set of delays in the receiver channels are added (e.g., through the first fiber length profile or the third fiber length profile), an additional contribution to the overall per-antenna phase is imparted as

$${Φ}_{i} = kn {ℓ}_{i} \qquad ( Equation 2 )$$

where lᵢ is the delay length in the i^{th} channel, and n is the mode index of the fibers, approximately equal to the refractive index of glass, ˜1.5. When the arrangement of the antenna elements 120 is uniform (i.e., periodic), then the total size of the spatial aperture of the antenna array 110 is α=(N−1)(xᵢ₊₁−xᵢ)=(N−1)Δx, wherein N is the total number of antenna elements 120 within the antenna array 110. Similarly, if the delays are uniformly spaced and arranged sequentially (i.e., if [symbol] ; is proportional to xᵢ), the temporal aperture size is L= (N−1)( [symbol] ᵢ₊₁− [symbol] ᵢ)=(N−1)Δ [symbol] . The total phase Φ, using the full spatial aperture α and temporal aperture L spans, may be defined as

$$Φ = k ( a sin ( α ) + nL ) \qquad ( Equation 3 )$$

The total phase Φ may be used to identify those wavevectors (i.e., those combinations of frequency f=ck/2π and AoA α, that appear identical to an image receiver configuration with spatial aperture α and temporal aperture L). Each position in the image plane corresponds to a single value of total phase Φ, therefore by plotting contours of total phase Φ in two dimensional (2D) k-space (spanned by kₓ, k₂ for 1D imaging system), each contour with a unique image plane position may be identified. As a result, each photodetector of photodetector array 190 (e.g., pixels of a short-wave infrared (SWIR) CCD linescan camera) may be mapped onto a contour in k-space. As used herein, the term “image plane” refers to the position occupied by the photodetector array 190 (e.g., the plane of photodetector array190). In an embodiment, an array of pickup waveguides (e.g., optical fibers or a photonic integrated circuit waveguide array) may be used to propagate the composite optical beam (i.e., “optical signal interference”) to the photodetector array 190 as detailed in U.S. Pat. No. 11,855,692. In such an embodiment, the “image plane” refers to the position of the array of pickup waveguides.

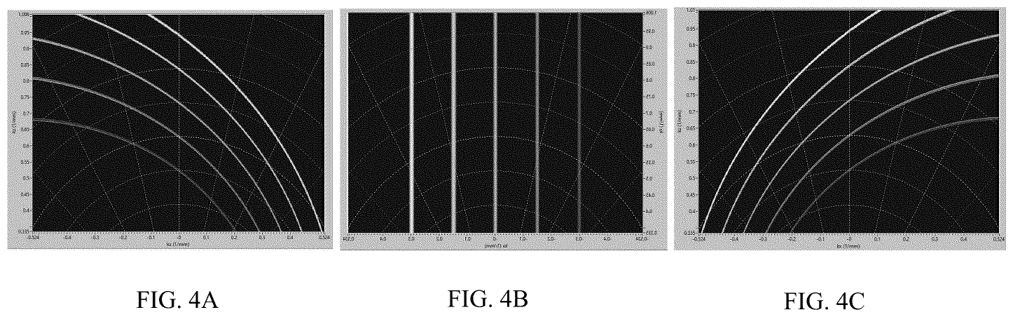

FIGS. 4A, 4B, and 4C illustrate plots of contours of ambiguity in 2D k-space. The plots show equal phase Φ contours for projection 0 (FIG. 4A), projection 1 (FIG. 4B), and projection 2 (FIG. 4C) with different temporal apertures (i.e., the first fiber length profile, the second fiber length profile, and the third fiber length profile, respectively).

Specifically, FIGS. 4A, 4B, and 4C each illustrate plots containing 5 equally spaced values of phase Φ plotted as contours in 2D kₓ-k_{z} space. The center of each plot corresponds to 32 GHz at boresight (a=0). The plots also contain (dotted) contours of constant frequency (5-GHz increments) and AoA (15-degree increments). The plot of FIG. 4A and the plot of FIG. 4C, which respectively correspond to the first fiber length profile and the third fiber length profile differ in the direction of the delay length increments (i.e., decreasing with channel index in FIG. 4C (negative slope) and increasing with channel index in FIG. 4A (positive slope)). The center plot shows the phase Φ contours for a configuration with L=0 (flat) (i.e., the second fiber length profile). Based on FIGS. 4A, 4B, and 4C, it is apparent that the phase Φ contours intersect each equi-frequency arc at a well-defined point, from which the AoA can be unambiguously determined. Hence, for narrow-band receivers, i.e., those sensitive only to k-vectors close to one particular constant-frequency arc, photodetector element (e.g., photodiode, pixel, etc.) positions (that map uniquely to phase Φ contours) correspond to AoA. Likewise, FIG. 4B shows how the intersections of the circular frequency contours with the uniformly spaced vertical F contours leads directly to the well-known uniformity of array beams in the ‘sine space,’ and the complementary arcsine dependence of the angular beam spacing with increasing angular separation from the boresight.

Mapping Image Frame Pixels into K-Space

A process to derive a mapping from photodetectors (e.g., photodiodes, pixels, etc.) in multiple temporal projections (e.g., projections 0, 1, and 2) onto 2D k-vectors (described equivalently by f and AoA, or by kₓ and k_{z}) may be shown by an example case when the azimuth angle α=0, and when the temporal aperture L=0. First, for azimuth angle α=0, two k vectors, k₁ and k₂ may be considered such that the temporal-aperture sampling interval DI satisfies

$$( {k}_{x} - {k}_{1} ) n Δ ℓ = 2 π \qquad ( Equation 4 )$$

Equation 4 may be rewritten as

$$( {k}_{2} - {k}_{1} ) n Δ ℓ = 2 π ( {f}_{2} - {f}_{1} ) \frac{n Δ ℓ}{c} = \frac{2 π ( {f}_{2} - {f}_{1} )}{FSR} \qquad ( Equation 5 )$$

In equation 5, the free spectral range (FSR) associated with the temporal aperture L is identified as FSR=c/nΔ [symbol] =(N−1)(c/L)Δ [symbol] . Comparing equation 5 with equation 4, demonstrates that the wavevectors satisfying both equation 4 and Φ1=a2=0, are separated in frequency by the FSR (i.e., (f₂-f₁)=FSR). From equation 4, equation 5, and equation 3 with a=0, the proportionality constant m that relates phase Φ to pixel position p, m=dΦ/dp, may be obtained as

$${m}_{\pm } = \frac{{Φ}_{2} - {Φ}_{1}}{{p}_{2} - {p}_{1}} = \frac{( {k}_{2} - {k}_{1} ) n ( \pm L )}{\pm \vert {p}_{2} - {p}_{1} \vert} = \frac{2 π ( N - 1 )}{N ( {d}_{out} / {d}_{pix} )} \qquad ( Equation 6 )$$

In equation 6, dₚᵢₓ is the pitch of the pixels in the photodetector array 190, and dₒᵤₜ is the size of the output beams (composite optical beam (i.e., “optical signal interference”)) on the image plane (e.g., the plane of photodetector array190), which is determined by the focal length f of the Fourier lens 181 (i.e., Fourier lens) included in the free space optics 180 and used for beamforming. As an example embodiment, the free space optics (e.g., Fourier lens 181) of the imaging receiver 100 may be designed such that the size of the output beams on the image plane dₒᵤₜ is 250 μm (matching the spacing of standard commercial fiber arrays for pickup (e.g., array of pickup waveguides) and routing to photodetectors), and typical SWIR camera pixels are 10-30 μm in size. The two cases for the proportionality constant m indicated by the subscript ‘±’ correspond to the direction of the fiber delay increments (i.e., the sign of the temporal-aperture slope of each of the first fiber length profile and the third fiber length profile). Opposite temporal-aperture slopes lead to a change in both the sign of the photodetector (e.g., pixel) spacing of the RF source images, and also in the sign of Δ [symbol] , and hence temporal aperture L=(N−1)Δ [symbol] , so that these sign changes cancel, yielding m=m=m.

When the temporal aperture L=0 (i.e., the second fiber length profile, flat temporal aperture, flat profile), two new k vectors may be considered, now with the same frequency, k₁=k₂=k, and different AoAs α₁, α₁, such that

$$k a ( sin {α}_{2} - sin {α}_{1} ) = 2 π ( N - 1 ) \qquad ( Equation 7 )$$

Equation 7 yields a proportionality constant m for the flat projection case (i.e., projection 1) of

$${m}_{0} = \frac{{Φ}_{2} - {Φ}_{1}}{{p}_{2} - {p}_{1}} = \frac{2 π ( N - 1 )}{N ( {d}_{out} / {d}_{pix} )} = m \qquad ( Equation 8 )$$

Equation 8 is the same as equation 6. Therefore, for all three temporal apertures L, the same value for the proportionality constant m is obtained. Similarly, as done above with equation 4, equation 7 may be rewritten as

$$k a ( sin {α}_{2} - sin {α}_{1} ) = \frac{2 π a}{{λ}_{RF}} ( sin {α}_{2} - sin {α}_{1} ) = 2 π ( N - 1 ) ( \frac{{d}_{ant}}{{λ}_{RF}} ) ( sin {α}_{2} - sin {α}_{1} ) = 2 π ( N - 1 ) \frac{( sin {α}_{2} - sin {α}_{1} )}{AFSR} \qquad ( Equation 9 )$$

In equation 9, the angular free spectral range AFSR is identified such that AFSR=λ_{RF}/dₐₙₜ, where dₐₙₜ=a/(N−1) is the antenna spacing. Comparing equation 9 with equation 7 illustrates that the two chosen k vectors satisfying both equation 7 and k₁=k₂ are separated in AoA by the AFSR, i.e., sinα₂-sinα₁=AFSR.

Given the proportionality constant m (i.e., the scaling factor between the total phase captured by the imaging receiver 100 for each temporal projection and photodetectors), the photodetector separations between imaged RF sources and their phase separation can be calculated. However, to uniquely associate photodetector values with total-phase contours in k-space, the absolute total phase for a particular photodetector value must be obtained. For example, total phase Φ(0) in the phase-to-photodetector (e.g., phase-to-pixel) mapping function

$$Φ ( p ) = m p + Φ ( 0 ) \qquad ( Equation 10 )$$

In equation 10, it is it is convenient to choose p=0 to be the center photodetector of the photodetector array 190, and consider a boresight RF source, so that in the absence of a temporal aperture (L=0), and with no optical phase-bias steering, the RF source image is centered at p=0. This leads immediately to the trivial result that for L=0

$${Φ}_{0} ( 0 ) = 0 \qquad ( Equation 11 )$$

When L≠0, still with no phase-bias steering, all frequencies are shifted in the direction of Δ [symbol] , and hence a boresight RF source with f>0 will be imaged to some photodetector position p≠0; the image position will converge to p=0 as f=→0. However, due to the periodicity of the aperture sampling, (temporal) grating lobes appear at frequency intervals equal to the FSR. Hence, a RF source with a frequency equal to the value of the FSR will also appear at p=0 in the form of a grating lobe, and hence

$${Φ}_{\pm } ( 0 ) = \frac{2 π}{c} n ( \pm L ) FSR = \pm 2 π ( N - 1 ) \qquad ( Equation 12 )$$

In equation 12, as before, the subscript indicates the sign of the time delay increments in the positive/negative-slope temporal-aperture projections (i.e., projection 0 and projection 2), and FSR is defined based on equation 5. Unlike the proportionality constant m, the value of Φ(0) is different for each temporal aperture L.

Finally, consider the utility of phase-bias steering to tailor the range of phases seen by the detector to match the spatial and spectral bandwidth of the imaging receiver 100 (e.g., to steer RF sources in the middle of the front-end bandwidth to the middle of the photodetector array 190). The imaging receiver 100 can apply arbitrary bias phases to each channel, using the same feedback modulation that compensates for mechanical perturbations of the optical fibers 140. By applying bias phases that are proportional to the corresponding antenna element 120 position (and hence to the corresponding delay length), the image on the photodetector array 190 can be steered to direct any RF source image onto any photodetector position. It is convenient to calibrate these steering phases in units of resolved beams, since the corresponding steering angles are frequency-dependent, but beams are not (since the frequency dependence of the beam direction cancels out the frequency dependence of the beam width/spacing). The simple relation describing the steering phases Φₛ(s=1, 2, . . . , N) that produces a steering shift of the image of b beams is

$${Φ}_{s} ( b ) = 2 π \frac{sb}{N} \qquad ( Equation 13 )$$

A steer of b beams shifts the frequency f of a boresight RF source that images at p=0 by

$$Δ {f}_{STR} = b ( \frac{FSR}{N} ) \qquad ( Equation 14 )$$

As a result, the frequency f appearing at p=0 becomes

$${f}_{p = 0} ≡ {f}_{ctr} = FSR + f {Δ}_{STR} = FSR ( 1 + b / N ) \qquad ( Equation 15 )$$

To shift the images so that this frequency is centered, the required steering bias-phase shifts that should be applied are obtained by solving equation 15 for b, and substituting the result into equation 13. This shift will change the values of total phase Φ±(0) in equation 12 by a factor of (1+b/N). To preserve the same center frequency for all projections, the bias steer b must be sign-inverted between the positive-slope and negative-slope projections (i.e., projection 0 and projection 2), such that b_=b₊, with b₀=0.

Combining equation 8 with equations 10-12, the pixel-to-photodetector conversion for all projections may be obtained

$${Φ}_{0} ( p ) = ( \frac{2 π ( N - 1 )}{N ( {d}_{out} / {d}_{pix} )} ) p = 2 π \frac{( N - 1 )}{N} ( \frac{p}{Δ {p}_{b}} ) {Φ}_{-} ( p ) = 2 π \frac{( N - 1 )}{N} ( \frac{p}{Δ {p}_{b}} - ( N + {b}_{-} ) ) {Φ}_{+} ( p ) = 2 π \frac{( N - 1 )}{N} ( \frac{p}{Δ {p}_{b}} + ( N + {b}_{+} ) ) \qquad ( Equation 16 )$$

In equations 16, Δp_{b}=dₒᵤₜ/dₚᵢₓ as the resolved-beam spacing in the image plane, in photodetectors (e.g., pixels). Equations 16 may be inverted to provide the photodetector values corresponding to each value of phase Φ, which in turn corresponds to a set of points (contour) in k-space, whose Cartesian coordinates can be obtained from equation 3 using

$$k = \sqrt{{k}_{x}^{2} + {k}_{z}^{2}} α = {tan}^{- 1} ( {k}_{x} / {k}_{z} ) \qquad ( Equation 17 )$$

Solving equations 16 for p, provides

$${p}_{0} ( {k}_{x} , {k}_{z} ) = Δ {p}_{b} ( \frac{N}{N - 1} ) \frac{{Φ}_{+} ( {k}_{x} , {k}_{z} )}{2 π} {p}_{+} ( {k}_{x} , {k}_{z} ) = Δ {p}_{b} [ ( \frac{N}{N - 1} ) \frac{{Φ}_{+} ( {k}_{x} , {k}_{z} )}{2 π} - N - {b}_{+} ] {p}_{-} ( {k}_{x} , {k}_{z} ) = Δ {p}_{b} [ ( \frac{N}{N - 1} ) \frac{{Φ}_{-} ( {k}_{x} , {k}_{z} )}{2 π} + N + {b}_{-} ] \qquad ( Equation 18 )$$

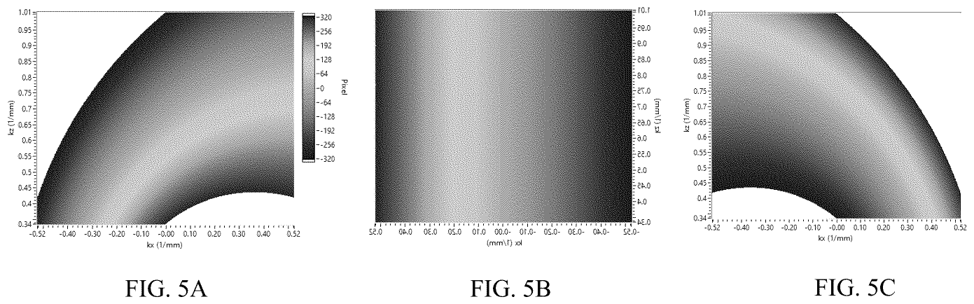

FIGS. 5A, 5B, and 5C illustrate photodetector (e.g., pixel) maps for 2D k-space with respect to each of the three different temporal aperture projections (i.e., the first fiber length profile, the second fiber length profile, and the third fiber length profile, respectively). The photodetector map in FIG. 5A corresponds to projection 0, the photodetector map in FIG. 5B corresponds to projection 1, and the photodetector map in FIG. 5C corresponds to projection 2. Comparing FIGS. 5A-5C with FIGS. 4A-C demonstrates the similarity between the mappings of photodetectors into k-space as shown in FIGS. 5A-5C and the total phase Φ contour plots of FIGS. 4A-C.

Based on the results of the mapping of the photodetector into k-space as discussed above, and in combination with the images from the photodetector array 190 obtained from the three different temporal-aperture projections, a visualization of the distribution of RF sources in k-space can now be obtained. First, a grid of points spanning the region of interest in k-space is defined, in the form of 2D arrays containing values of kₓ and k_{z}. The number of elements in each dimension should be equal to or greater than the number of photodetectors (e.g., camera pixels) within the FSR (i.e., NΔp_{b}). As an example, wherein N=32, dₒᵤₜ=0.25 mm, dₚᵢₓ=12.5 μm, then NΔp_{b}=640. The photodetector mappings of equation 18 are used to index the elements of the camera frames (off-set by NΔp_{b}/2 to account for the choice to set p=0 at the center of the image). Then each element of the output scene can be obtained from a combination of the photodetectors that contribute to that element's k-space coordinates. There is flexibility in choosing how to combine the inputs from the multiple projections. There are also numerous ways to configure the imaging receiver 100 to modify/optimize the photodetector array 190 output. For example, tapered aperture weights can be used to suppress sidelobes in the image, at the expense of broadening the peaks. Alternatively, the photodetector array 190 output can be deconvolved with the known (by analytical calculation or lab calibration measurement) point-spread function (PSF) to simultaneously suppress sidelobes and sharpen the peaks.

As an example, a reconstructed scene based on a scene containing only one RF source will be first described. Each element of the reconstructed scene is obtained from a combination of photodetector values, with the number of photodetectors contributing equal to the number of temporal projections captured by the imaging receiver 100. As discussed above with reference to FIG. 3B, the imaging receiver 100 may capture two oppositely sloped temporal projections (i.e., projection 0 and projection 2) at high speed for low-latency RF source location and frequency identification, with a third, flat projection (i.e., projection 1) used primarily for heterodyne downconversion and waveform recovery with IF photoreceivers.

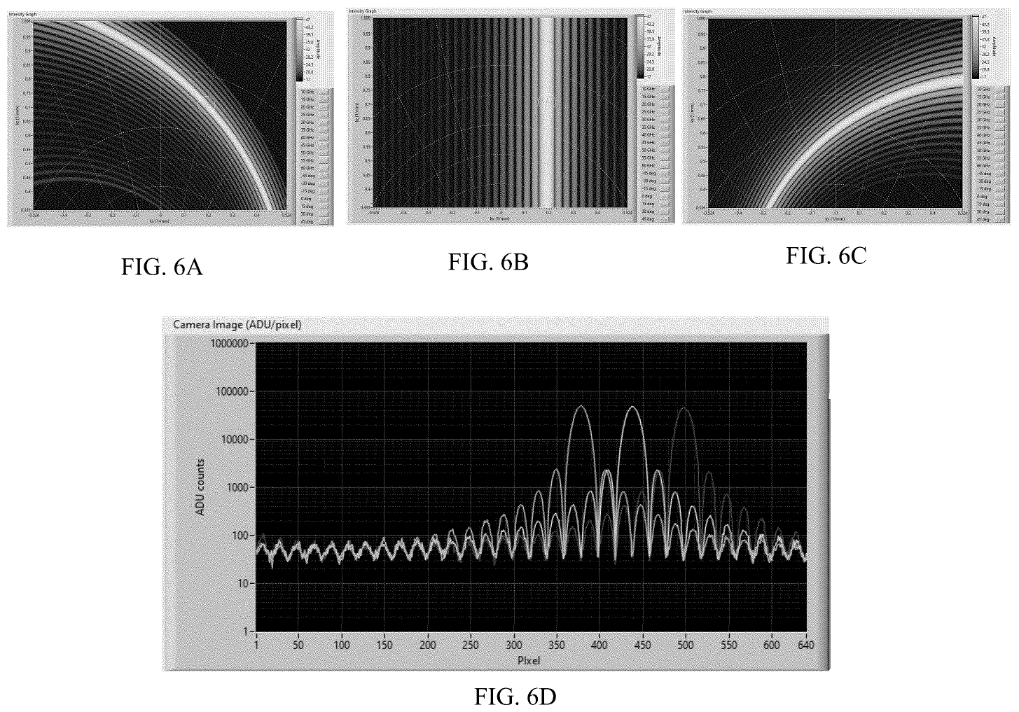

FIGS. 6A, 6B, and 6C illustrate the k-space scene corresponding to each of the three temporal projections (i.e., projection 0 in FIG. 6A, projection 1 in FIG. 6B, and projection 2 in FIG. 6C). As expected, the single-projection reconstructions look very similar to FIGS. 4A-4C, except sharp contours are replaced by broad, thick lines and weaker sidelobe contours, owing to the finite resolution of the imaging receiver 100 (in both spatial and temporal apertures). Note that the color scale of the plots is logarithmic (dB ADU counts). The RF source's true location in k-space (f=35 GHz, a=) 15° is indicated in each plot by a circle.

FIG. 6D illustrates a combined plot of the photodetector array 190 outputs for each of the three temporal projections. Projection 0 (i.e., negative-slope) is illustrated in green, projection 1 (i.e., flat) is illustrated in gray, and projection 2 (i.e., positive-slope) is illustrated in red.

Examining FIGS. 6A-6C, it is clear that by overlaying the three plots, the true RF source location lies at the intersection of the main-lobe contours in each projection. This observation informs a strategy for combining the projections into a single k-space scene plot. An example of one combination strategy may be an averaging of the two or three temporal projections.

FIGS. 7A and 7B depicts the result of combining the three image frames with a logarithmic average, i.e., the n^{th} root of the product of the n photodetector (e.g., pixel) values that contribute to each element of the k-space grid. For example, FIG. 7A depicts a combination of two temporal projections (i.e., projection 0 and projection 2). FIG. 7B depicts a combination of three temporal projections (i.e., projection 0, projection 1, and projection 2). As such, with n=2 in FIG. 7A and n=3 in FIG. 7B. The logarithmic average may be represented as

$${S}_{out} ( {k}_{x} , {k}_{y} ) = {( {\prod }_{s = 1}^{n} {P}_{s} ( {p}_{s} ( {k}_{x} , {k}_{y} ) ) )}^{1 / n} \qquad ( Equation 19 )$$

In equation 19, subscript s indicates the projection (s∈{−,+,0}). Pₛ(pₛ(kₓ, k_{y})) indicates the photodetector value (ADU) in the s^{th} projection at the photodetector corresponding to the k-space location (kₓ, k_{y}). Sₒᵤₜ(kₓ, k_{y}) in the reconstructed scene. Such combination results in a strong peak located at the correct RF source location, but there remain sidelobes that are strongest along main-lobe contours from each individual photodetector array (e.g., camera) image. These sidelobes could impair the detection of weaker signals.

To compensate for the impairments caused by the sidelobes, a weighting scheme may be incorporated in the combination of the projections. For example, the combined output at each k-space element can be weighted based on the relative amplitudes of the photodetector contributions to the antenna element: since all projections are obtained from the same front end, the amplitude of the peak signal should be the same in all of them, whereas the dominant sidelobes originate from the intersections of the main-lobe contours with the sidelobes in the other projection(s) and thus the photodetector values being combined are unequal in amplitude.

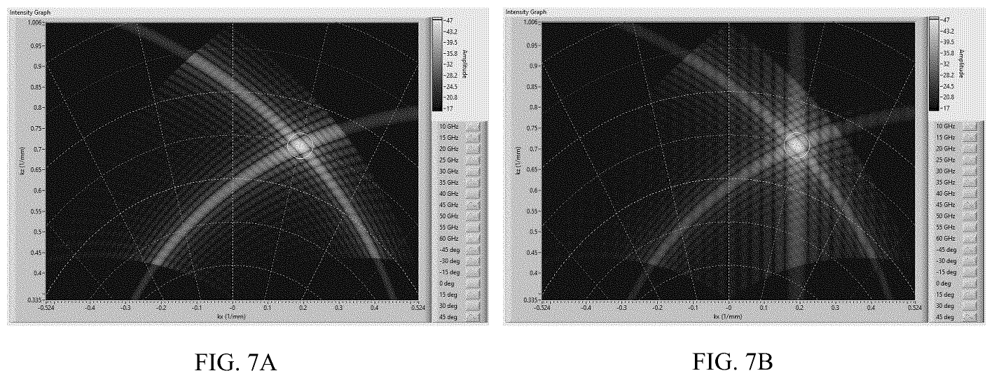

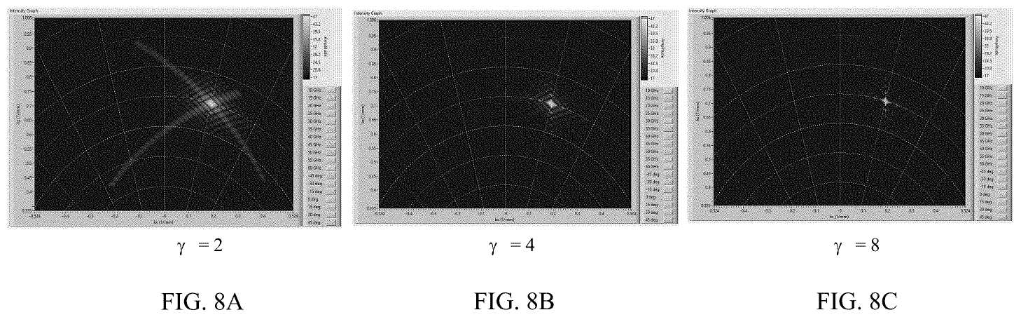

FIGS. 8A, 8B, and 8C illustrate an example of the results of combining the projections with a weighting coefficient that decreases as the variation among the corresponding photodetector values grows:

$${S}_{out} ( {k}_{x} , {k}_{y} ) = {( {\prod }_{s = 0}^{n} {P}_{s} ( {p}_{s} ( {k}_{s} , {k}_{y} ) ) )}^{1 / n} / {( 1 + \frac{{σ}_{n}}{{μ}_{n}} )}^{γ} \qquad ( Equation 20 )$$

In equation 20, σₙ and μₙ are, respectively, the standard deviation and mean of the n photodetector values combined at (kₓ, k_{y}), and γ is an adjustable parameter. When the normalized range of variation among the combined photodetector values is small, σₙ→0, the denominator in equation 20 approaches 1, and Sₒᵤₜ is the same as in equation 19. When the variation among the photodetector values grows, however, the denominator becomes large and Sₒᵤₜ is diminished. The extent of the suppression of Sₒᵤₜ based on this variation among the projections can be adjusted using weight parameter γ, with a larger weight parameter y suppressing more strongly. Setting weight parameter γ=0 restores the photodetector combination of equation 19.

As evidenced by FIGS. 8A-8C, equation 20 effectively suppresses the sidelobes while preserving the RF source itself. For example, FIG. 8A illustrates the reconstructed k-space scene from the two oppositely slope projections (i.e., projection 0 and projection 2) where weight parameter γ=2. In FIG. 8B, weight parameter γ=4 and in FIG. 8C, weight parameter γ=8. For high values of weight parameter γ, the few remaining side-lobes are regularly spaced along a line of constant frequency and a line of constant kₓ, corresponding to the directions within the k-space where the sidelobe amplitudes are equal, which renders the weighting of equation 20 ineffective at those locations.

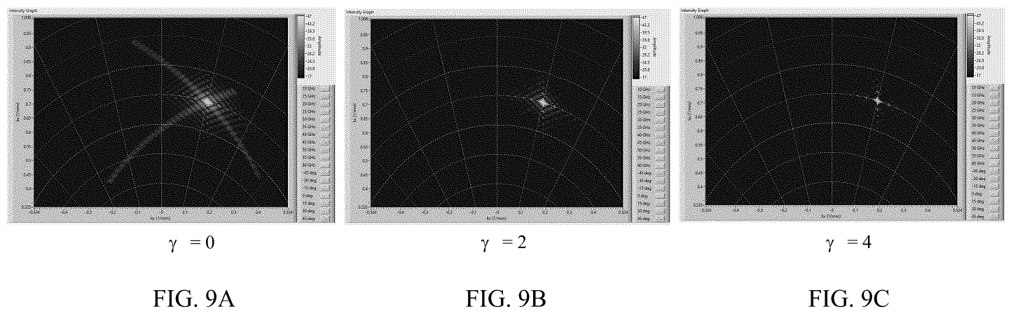

The combination of formulas presented above address the issue of sidelobes only within the context of how the projections are combined, while sidelobes can also be addressed in other ways such as aperture tapering and PSF deconvolution, as mentioned previously. Aperture tapering can be implemented in a variety of ways, such as by inserting variable attenuators in the signal paths of each antenna element 120. An example of the results obtained using an aperture tapered with a 40-dB Chebyshev window, for various weight parameter y values, is shown in FIGS. 9A, 9B, and 9C. As expected for this window, sidelobes are effectively eliminated in the image frames, while the main-lobe peak is broader owing to the effective reduction of the physical size of the aperture by the window. Further, the residual main-lobe contours can be eliminated using a smaller weight parameter γ as compared to FIGS. 8A-8C.

Determining RF Source Locations in K-Space from Image Frame Peaks

The operating concept behind the disclosed k-space imaging receiver 100 is to utilize multiple projections with different, engineered frequency dispersion, in conjunction with the inherent spatial dispersion (AoA sensitivity) of a phased-array antenna 110, to extract unambiguous frequency and AoA information from detected RF sources. In practice, for the imaging receiver 100, a detected RF source is one that produces a peak on the photodetector array 190 (e.g., a SWIR CCD camera) that is detectable above the photodetector array 190 noise. Hence, any process for extracting RF sources from a set of image frames corresponding to various projections begins with detecting peaks in those image frames, and comparing/correlating the locations of those peaks in the image frames obtained from the multiple projections. In the detailed descriptions above, expressions were derived which related the photodetector numbers in the image frames to the contours of constant phase in k-space, and illustrated how the intersections of those contours indicate visually the locations of RF sources in k-space. The above detailed descriptions also demonstrated how combining extruded image frames into the 2D k-space with appropriate weighting can enhance the visual isolation of a true RF source from its ambiguity contours in each image frame corresponding to a specific projection. The subsequent descriptions detail how to directly calculate a RF source's k-space coordinates (frequency and AoA/azimuth) from the pixel numbers of its peaks.

Peak-finding algorithms for 1D data such as the photodetector array 190 frames/images in the system under consideration are readily available in common mathematical computing environments such as Matlab, Python, LabVIEW, etc., and will not be discussed extensively here. Their availability and ability to provide correct results, within reasonable and obvious limits regarding SNR, will be assumed going forward. Suffice it to point out that such algorithms share common adjustable parameters, including absolute threshold value and minimum peak width, which must be set appropriately for the imaging receiver 100. For example, in an embodiment of the imaging receiver 100, the imaging receiver 100 includes 32 antenna elements (i.e., channels), a photodetector array 190 in which photodetectors (e.g., CCD pixels) are spaced at 12.5-μm pitch, an optical system has a PSF beam pitch of 250 μm, or 20 photodetector (e.g., pixels), and main-lobe peaks from RF sources are 40 photodetectors wide (full width, null to null). Hence, using peak detection with a minimum peak width of 40 photodetectors effectively eliminates spurious peak detections from camera noise, and also reduces sensitivity to sidelobes, since sidelobes are only half as wide as the main lobe. Likewise, the peak detection threshold should be set to a level close to or just above the photodetector array 190 read noise, which is a function of its gain setting.

To extract RF source location from peak photodetector positions in two image frames captured using different projections, first equation 3 is solved for k and α in terms of total phase Φ; then set up simultaneous equations involving the expressions for total phase Φ in the two projections, using them to eliminate one of the two k-space coordinates and allowing to solve for the other. Replacing total phase Φ with expressions involving photodetector positions p according to equation 16 enables unambiguous determination of one coordinate. As an example, consider Φ+ and Φ, taking the difference between them according to equation 3:

$$\begin{matrix}{Φ}_{+} - {Φ}_{-} = k ( a sin α + {nL}_{+} ) - k ( a sin α + {nL}_{-} ) \\ = kn ( {L}_{+} - {L}_{-} ) ,\end{matrix} \qquad ( Equation 21 )$$

which eliminates a and enables solving for k as

$$k = \frac{{Φ}_{+} ( {p}_{+}^{*} ) - {Φ}_{-} ( {p}_{-}^{*} )}{2 nL} \qquad ( Equation 22 )$$

where pₛ* indicates the photodetector position of a peak in the image frame obtained using the projection indicated by subscript s, and the fact that in the present embodiment of the imaging receiver 100, the temporal aperture sizes in the positive slope and negative slope projections are equal, L=−L. (In general, the sizes of the apertures need not be equal, in which case distinct values of L₊ and L− must be tracked through the analysis.)

Equations 16 provide expressions for total phase Φₛ in terms of ps*, or equivalently, equation 10 may be used along with the values of m and Φₛ(0) obtained previously in equations 6 and 12, respectively. The AoA a can then be obtained for this k value using equation 3 with either projection's Φ value individually, or by using both projections combined, e.g., by adding the phase expressions:

$$\begin{matrix}{Φ}_{+} + {Φ}_{-} = k ( 2 a sin α + {nL}_{+} + {nL}_{-} ) \\ = 2 ka sin α\end{matrix} \qquad ( Equation 23 )$$

and solving for α

$$α = {sin}^{- 1} [ \frac{{Φ}_{+} + {Φ}_{-}}{2 k a} ] \qquad ( Equation 24 )$$

Some additional insight may be gained by re-casting the solutions of equations 22 and 24 above in terms of the free spectral ranges (FSR and AFSR) defined previously. Normalized coordinate \tilde{p}_{±} may introduced for specifying the locations of peaks in units of the size of the resolved beam space rather than photodetector, i.e., let

$${\tilde{p}}_{+} ≡ \frac{{p}_{\pm }}{N Δ {p}_{b}} \qquad ( Equation 25 )$$

Equation 25, along with the earlier stipulation that p=0 at the center of the image frame, means that the range of possible values of the normalized coordinate \tilde{p}_{±} is [−1/2, 1/2]. Substituting the expressions for the phases Φ from equation 16 into equation 22, in terms of the normalized coordinate \tilde{p}_{±}, and substituting expressions for k and L in terms of frequency f and change in delay length Δ [symbol] , respectively, yields

$$f = \frac{ck}{2 π} = ( \frac{c}{n Δ ℓ} ) [ \frac{{\tilde{p}}_{+} - {\tilde{p}}_{-}}{2} + ( {\tilde{b}}_{s} + 1 ) ] \qquad ( Equation 26 )$$

where for dimensional consistency, normalized units have been adopted for the optical beam steer, i.e., \tilde{b}ₛ=\tilde{b}ₛ/N. Similarly, using equations 16 and 26 in equation 24, with substitution for α in terms of dₐₙₜ, yields

$$sin α = ( \frac{1}{{d}_{ant}} ) \frac{{\tilde{p}}_{+} + {\tilde{p}}_{-}}{( 2 f / c )} = ( \frac{{λ}_{RF}}{{d}_{ant}} ) \frac{{\tilde{p}}_{+} + \tilde{p}}{2} \qquad ( Equation 27 )$$

Finally, recalling the free spectral ranges: FSR=c/nΔλ and AFSR=Δ_{RF}/dₐₙₜ, and noting that according to equation 15, \tilde{b}s+1=f_{ctr}/FSR, the following simple expressions for frequency f and AoA α are obtained:

$$f = FSR ( Δℓ ) [ \frac{{\tilde{p}}_{+} - {\tilde{p}}_{-}}{2} ] + {f}_{ctr} sin α = AFSR ( f , {d}_{ant} ) [ \frac{{\tilde{p}}_{+} + {\tilde{p}}_{-}}{2} ] \qquad ( Equation 28 )$$

From these expressions, numerous intuitive insights into the behavior of the imaging receiver 100 may be obtained. Owing to the oppositely sloped fiber-length profiles, peaks in the two sloped projections move in opposite directions as a RF source's frequency f changes. On the other hand, peaks move in tandem as a RF source's AoA α changes. The free spectral ranges provide the natural scale factors relating (normalized) peak positions to frequency f and AoA α. Note also that the functional dependence of the free spectral ranges is called out explicitly in equation 28: the FSR is determined solely by the increment in the fiber lengths (temporal aperture sampling interval), whereas the AFSR depends on the both the antenna spacing (spatial aperture sampling interval) and the frequency f. When a RF source has peaks at the same position in both projections, its frequency f is the center frequency far, set by the calibration beam steer.

### Multiple Simultaneous RF Sources

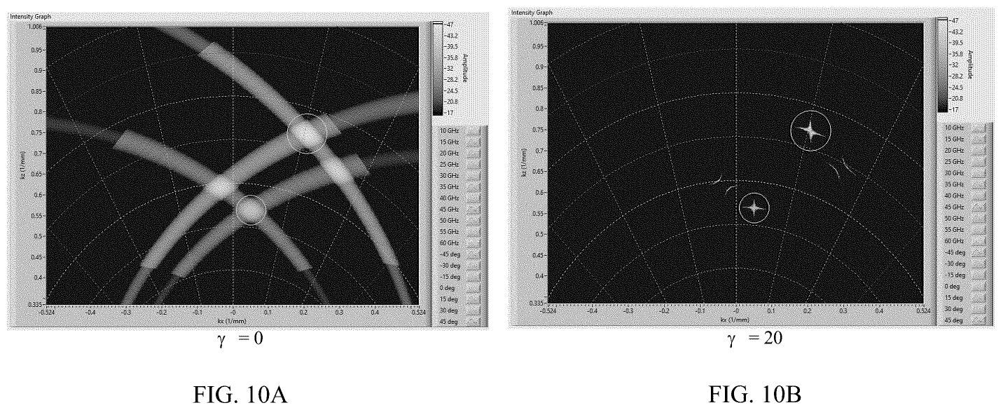

The above expressions provide candidate RF source locations in the 2D k-space when evaluated for every pair of peaks found in the image frames from different projections. For scenes containing only a single RF source, there is one peak in each image frame and the solution is unique and unambiguous. When there are multiple peaks in the image frames, however, it is necessary to identify which peak pairs are corresponding peaks, i.e., corresponding to the same source. Mismatching peaks generates solutions that are not true RF sources; this situation is illustrated in the plots of FIGS. 10A and 10B.

FIGS. 10A and 10B illustrate scenes in 2D k-space containing two simultaneous RF sources using a combination of two oppositely-sloped projections (i.e., projection 0 and projection 2). FIG. 10A illustrates the ambiguity arising from intersections of contours corresponding to different RF sources. In FIG. 10A, the weight parameter γ is equal to zero, to clearly show the four contour intersections corresponding to candidate source locations in k-space. The true locations of the RF sources are indicated by the white circles. However, as illustrated in FIG. 10A, there are two additional intersections that are not true RF sources.

The same situation discussed earlier in the context of sidelobes also obtains when separate RF sources are concerned: RF sources with unequal powers at the imaging receiver 100 will produce unequal peak heights, whereas the peaks that correspond to the same RF source will have nearly equal heights. Hence, combining peaks according to a weighting factor such as that in equation 20 will help to discriminate among candidate RF source locations. FIG. 10B shows the resulting scene with the weight parameter γ=20. Note that suppressing spurious sources will generally require large values of weight parameter γ, since the peak heights of sources may be nearly equal, unlike sidelobes; further, when RF sources are very nearly equal, this method of discriminating between true and spurious peak-contour intersections will not avail; other criteria must be used to separate them, e.g., time-domain properties such as pulse modulation characteristics. If all else fails, it should still be noted that the number of candidate sources remains small compared to the volume of k-space that must be swept thorough repeatedly in conventional receiver designs: it is much faster to tune a local oscillator (LO) to a small number of discrete frequencies to look for a signal of interest than to sweep it blindly over the entire operational bandwidth.

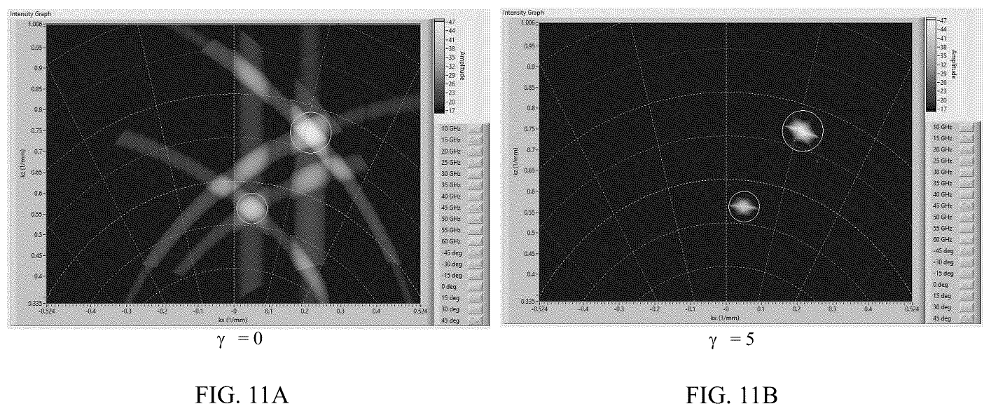

FIGS. 11A and 11B depicts the scene from FIGS. 10A and 10B rendered using the same settings, except FIGS. 11A and 11B include the third (flat) projection (i.e., projection 1). From FIG. 11A, it is apparent that even without the weight parameter γ(γ=0), using a third projection (i.e., projection 1) resolves the ambiguity seen in FIG. 10A, since only at true RF source locations do peaks in all three projections (i.e., projection 0, projection 1, and projection 2) intersect at the same location. FIG. 11B renders the scene with a weight parameter γ=5; owing to the third projection (i.e., projection 1), practically all of the sidelobe contours are suppressed using a much smaller weight parameter γ as compared to FIG. 10B, which utilizes only two projections (i.e., projection 0 and projection 2).

### 2-Dimensional (2D) Antenna Array

The above discussions are directed to an imaging receiver 100 that includes a linear (i.e., 1-dimensional (1D)) periodic antenna array that allows signals from a RF source(s) to be located in a 2-dimensional k-space (frequency f and AoA α (i.e., angle of incidence in a plane parallel to the antenna array, azimuth angle)). However, as detailed below, similar concepts as those discussed above may be utilized in an imaging receiver 200 that includes a 2-dimensional (2D) aperiodic antenna array 210, including antenna elements 120, that allows signals from a RF source(s) to be located in 3-dimensional k-space (frequency f, azimuth angle, and elevation angle). Imaging receiver 200 includes laser 125, and splitter 127, fibers 130, fiber bundle 160, polarizing beam-splitter 182, quarter-wave plate 183, and filter 184, biconvex spherical lens 181, photodetector array 190, first lens 185. For the sake of brevity, and where applicable, the interference region optics 180 and other components will be discussed with respect to only one of the respective different fiber length profiles. The modulated optical signals (e.g., the optical field) output from the fiber output array 160A (160B, 160C) may pass through a polarizing beam-splitter 182A (182B, 18C), phase modulator 191, second lens 192, and beam splitter 193, phase controller 195, for which a detail disclosure is not repeated here for conciseness purposes. Imaging receiver 200 may also include a erbium-doped fiber amplifier (EDFA) 126 connected to laser 125. However, although not illustrated in the imaging receiver 100, a similar EDFA 126 may also be provided in the imaging receiver 100.

With respect to the 2D antenna array, the azimuth angle and the elevation angle may be referred to together as the angles of arrival (AoA). As such, imaging receiver 200 may fully characterize the locations of RF sources in signal frequency and azimuth and elevation AoA, which are referred to below as (ω_{RF}, α, ε). The symbol ΦRF is used in this section to represent frequency with respect to the imaging receiver 200 in order to avoid confusion with the symbol f, which is used in this section to represent the focal length f of the lens 181 (e.g., Fourier lens).

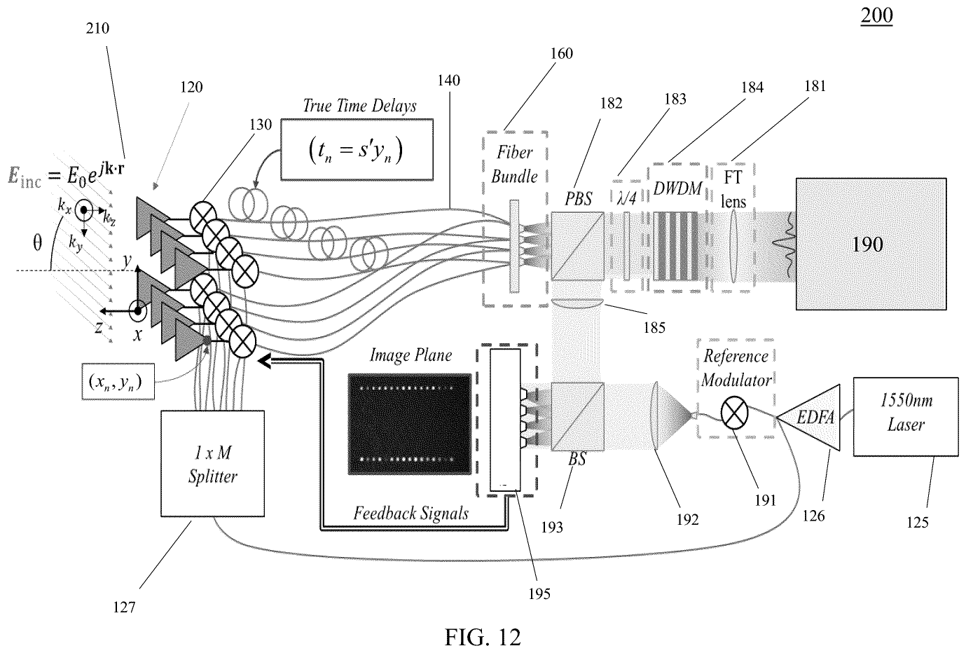

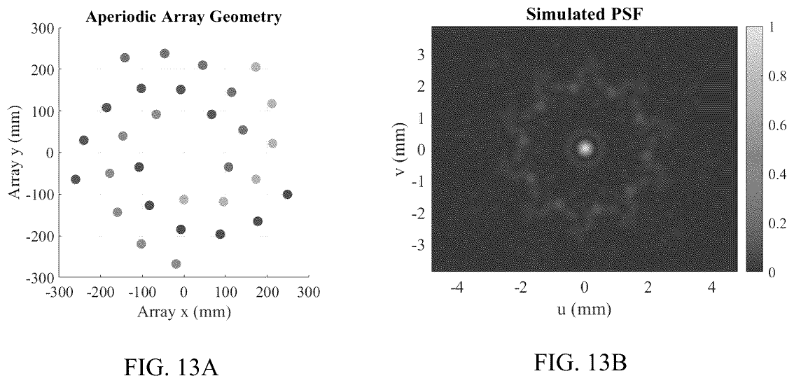

As illustrated in FIG. 12, antenna array 210 includes a plurality of N antenna elements 120. The antenna array 210 depicted is simplified for illustrative purposes. In one embodiment, the antenna array 210 may be in the form of an aperiodic arrangement of thirty antenna elements 220 (i.e., N=32) as illustrated in FIG. 13A. FIG. 13B illustrates a PSF plot of the antenna arrangement illustrated in FIG. 13A

As further illustrated in FIG. 12, RF plane waves (an abstract illustration of a far-field plane wave may be represented as E_{inc}=E₀exp[jk·x]) may be incident upon the antenna array 210 arranged in the x-y plane. The RF plane wave may have a spatial frequency k=|k|=ΦRF/c and an oblique incidence angle θ, and creates a phase distribution across the antenna array 210 determined by the frequency of the wave Φ_{RF}=2πf_{RF}, specified by azimuth angle «, and elevation angle ε, and antenna element 120 positions x=(x, y). The phase distributions across the antenna array 210 together with the frequency ORF uniquely determine the k-vector of each plane wave sampled by the antenna array 210. The phase Φₙ at each antenna element 120 is a dot product of the wave vector k and the antenna position vector Xᵢ as illustrated in equation 1.

The fiber output array 160 is a scaled replica of the antenna array 210. Therefore, if the i^{th} antenna element 220 position is (Xᵢ, Yᵢ) and the i^{th} optical fiber 140 position is (xᵢ, yᵢ), then xᵢ,=sXᵢ and yᵢ,=sYᵢ, wherein s represents a scaling factor. A similar scaling factor is represented above with respect to a linear array as dᵢₙ/dₐₙₜ. As discussed above with respect to the imaging receiver 100, through an optical Fourier transform by biconvex spherical lens 181 (e.g., Fourier lens) of focal length f with optical wavelength λ, the spatial frequency distribution sampled by the antenna array 210 scaled by the factor s is represented in (u (i.e., azimuth/horizontal), v (i.e., elevation/vertical)) space at the Fourier plane of the optical processor by the expression:

$${U}_{I} ( u , v ) = \frac{{U}_{0} ( u , v )}{j λ f} \times {\sum }_{i} {A}_{i} exp [ - j ( {k}_{x} + \frac{2 π s}{λ f} u ) {x}_{i} ] \times exp [ - j ( {k}_{y} + \frac{2 π s}{λ f} v ) {y}_{i} ] + c . c . \qquad ( Equation 29 )$$

In equation 29, U₀(u, v) represents the distribution of optical power across the Fourier plane arising from the Fourier transform of the individual fiber modes and Aᵢ represents the sideband power present in the i^{th} optical fiber. For the purpose of this explanation, all Aᵢ are taken to be approximately equal, but this condition is not required. The term Uris used to denote the field at the Fourier plane for the case where all path lengths (i.e., the length of each optical fibers 140) from each antenna element are identical, while the term U_{F} is used to denote the Fourier field generated when a FAWG is inserted.

The spot location at the Fourier plane in (u, v) space for each RF source in the scene is defined through the projections of k upon the antenna array 210. Since the antenna elements 120 are distributed in two dimensions, the antenna array 210 is sensitive to both azimuthal and elevation AoAs. However, since kₓ and k_{y} depend upon both frequency and angle, for a broadband imaging system the spot location on the image plane is ambiguous. To address this, as discussed above with respect to the linear antenna array, different fiber length profiles may be introduced to the imaging receiver 200. The fiber length profiles may be introduced through a FAWG in which the time delay in each optical fiber 140 is linearly proportional to the vertical position of the optical fiber 140 in the antenna array 210; this creates an additional phase that is exclusively proportional to the source frequency determined by the time delay in the i^{th} optical fiber ti and RF angular frequency Φ_{RF}. As a result, the PSF at the image plane of the optical processor (which is equivalent to the position occupied by the photodetector array 190 or the array of pickup waveguides) is steered horizontally by kₓ, and vertically by both k_{y} as well as additionally by the frequency Φ_{RF}:

$${U}_{F} ( u , {v}^{′} ) = \frac{{U}_{0} ( u , {v}^{′} )}{j λ f} \times {\sum }_{i} {A}_{i} exp [ - j ( {k}_{x} + \frac{2 π s}{λ f} u ) {x}_{i} ] \times exp [ - j ( {k}_{y} + \frac{2 π s}{λ f} {v}^{′} ) {y}_{i} ] \times exp [ j ( {ω}_{RF} - \frac{2 π {s}^{′}}{λ f} {v}^{′} ) {t}_{n} ] + c . c . \qquad ( Equation 30 )$$

In equation 30, s′ is the ratio of the vertical extent of the fiber array to the time delay difference between the longest and the shortest fiber, and v′ denotes the vertical coordinate of the image plane fed by both an RF array distributed in y and optical fiber lengths proportional to vertical antenna element position. PSF measured with a specific value of s′ may be referred to as a projection of the RF field at the antenna array 210. Note that u=u′ is flat because the time delay profile is flat along the horizontal direction; in this embodiment horizontal spot location is used to correlate RF sources between projections.

For any polychromatic imaging system, the spot location as determined individually by in (u, v) space or in (u, v′) space is fully ambiguous with regard to the RF source coordinates (WRF, a, ¿) as any coordinate in u corresponds to a continuum of (WRF, a) and any coordinate in v or v′ corresponds to a continuum of (WRF, 8). As detailed below, only when both fiber profiles are used at the same time may source locations in all three dimensions be determined.

The formulation for PSF generation in the optical processor takes the form of a Fourier transform of the superposition of the optical fields at each optical fiber location in the launch plane of the optical layout. As a result, the output field in either (u,v) (for the flat profile) or (u,v′) (for the FAWG) is a distribution of amplitudes and phases across the Fourier plane. When the system is properly aligned, the RF phase front modulated on the optical carrier can be thought of as a plane wave at the input of the optical processor, or notionally a constant in ‘real’ space, which is represented by a delta function in Fourier space. For this diffraction-limited optical system, the delta function is manifested by an envelope around the notional location of the delta function in the Fourier plane, its location determined exclusively by the in-phase condition of all elements in the fiber array 160 and a spot size (or output waist) determined by the focal length of the Fourier lens 181, the optical wavelength, and the size of the input fiber array 160.

As an example, the antenna elements 120 may be linear tapered slot antennas, which may restrict the operational field-of-view to approximately ten degrees, or five degrees off broadside in any direction. Within this region, the kₓ and k_{y} projections may be assumed to be linearly proportional to the angles α and ε. Through simulations, the error associated with this assumption has been shown to be two orders of magnitude smaller than the resolution of the system as defined by the array diameter and maximal time delay difference. Therefore, it can be shown that the peak location of a given PSF in (u,v) or (u,v′) space follows the source coordinates through the system of equations

$$u ( {ω}_{RF} , α ) = - \frac{λ f}{2 π s} \frac{{ω}_{RF}}{c} α v ( {ω}_{RF} , ε ) = - \frac{λ f}{2 π s} \frac{{ω}_{RF}}{c} ε {v}^{′} ( {ω}_{RF} , ε ) = \frac{λ f}{4 π s} \frac{{ω}_{RF}}{c} ( \frac{s}{{s}_{0}} - 2 ε ) - {v}_{d}^{′} \qquad ( Equation 31 )$$

where so≡s′/c has been introduced to simplify analysis, and where

$${v}_{d}^{′} = \frac{λ f}{4 π {s}_{0} c} {ω}_{d} \qquad ( Equation 32 )$$

steers a predetermined design frequency ω_{d} to the center of the FAWG PSF. The design frequency Ω_{d} may be selected to be in the center of the Ka band, taking a value of 33 GHZ. The design frequency ω_{d} selection is implemented by the application of fixed calibration bias phases to the optical modulators, which steer a boresighted design-frequency source to the center of the photodetector array 190 by canceling out the FAWG time-delay phases for that frequency.

The system may be solved by identifying the optical angular frequency

$${ω}_{opt} = \frac{2 π c}{λ} \qquad ( Equation 33 )$$

and introducing a new coordinate

$$\tilde{v} ≡ 2 ( {v}^{1} + {v}_{d}^{′} - v ) \qquad ( Equation 34 )$$

After rearrangement of variables and unknowns, the solution to equation 31 takes the form

$$α = \frac{s}{{s}_{0}} ( \frac{u}{\tilde{v}} ) ε = - \frac{s}{{s}_{0}} ( \frac{v}{\tilde{v}} ) {ω}_{RF} = ( \frac{{ω}_{opt} {s}_{0}}{f} ) \tilde{v} \qquad ( Equation 35 )$$

Equations 35 directly solve equations 31, and may be evaluated instantaneously by any modern computer. Indeed, evaluation of the equation 35 for specific values of (u,v,v′) returns source coordinates in approximately 0.5 ms. The time scale for peak detection is on the order of 1 ms, indicating that even consumer-grade computer hardware is capable of at least kilohertz-rate source detection if both fiber profiles may be measured concurrently. Further development of peak detection algorithms may significantly extend the operational capability of this approach in both speed and dynamic range, and may bear fruit in future work.

The measured values of u, v, and v′ may be obtained using a peak detection algorithm as discussed above with respect to the utilization of the linear antenna array 110. For example, the peak detection algorithm may consist of a threshold operation followed by a low-pass filter to remove high-frequency noise from the photodetector array 190 sampled images representing the RF beamspace. This algorithm is applied to the flat-profile PSF (with coordinates u and v) and the FAWG PSF (with coordinates u and v′). As the insertion of the FAWG does not affect source location in u as discussed above (i.e., u=u′), the u coordinate may be used to correlate pairs of peaks located in the two PSFs corresponding to the same emitter (i.e., RF source) in the scene. Following peak detection, source identification is accomplished through evaluation of equation 35 through the detected values of (u,v,v′).

To investigate the viability of this approach, a simulated scene was generated in MATLAB using a model of the system with experimentally realizable source locations.

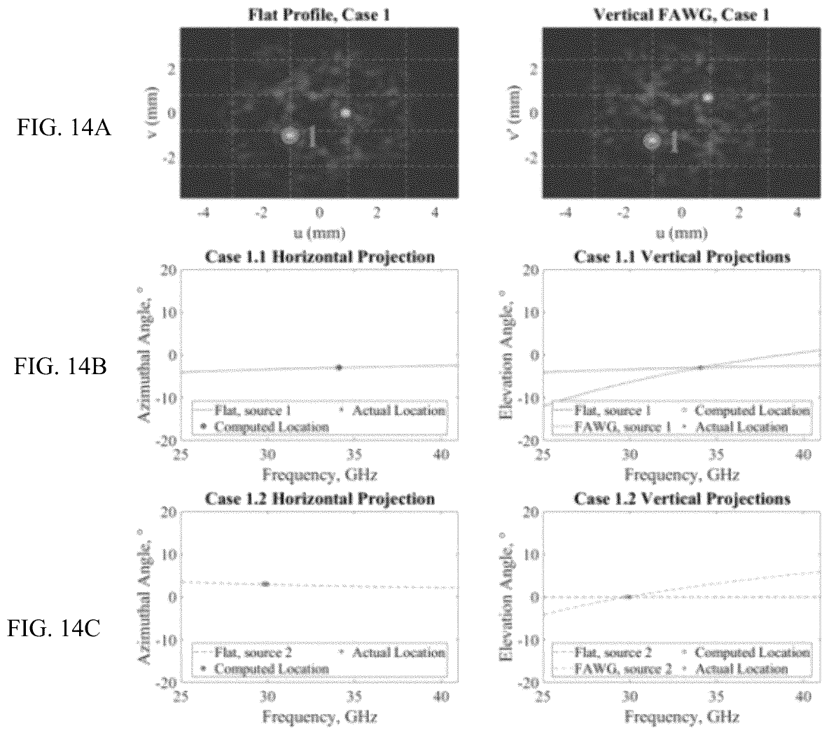

The simulated test case consists of two sources with coordinates (ω_{RF1}, α₁, ε₁)=(34 GHZ,−3°,−3°) and (ω_{RF2}, α₂, ε₂)=(30 GHz, 3°,) 0°. The associated PSF is shown in FIG. 14A, with the detected locations of the two peaks encircled in blue and red, a convention that will continue throughout this work. With respect to equations 31, the solution spaces in u for each source determined by the detected location of each peak are shown in FIG. 14B; while the corresponding solution spaces in v (blue) and v′ (red) are shown in FIG. 14C. As shown, the source locations are computed with extremely high accuracy. FIGS. 14A-14C visualize the relationship between the photodetector array 190 data space and the source coordinate space, and how the source locations in (ω_{RF}, α, ε) space may be computed through measurement of (u, v, v′) space.

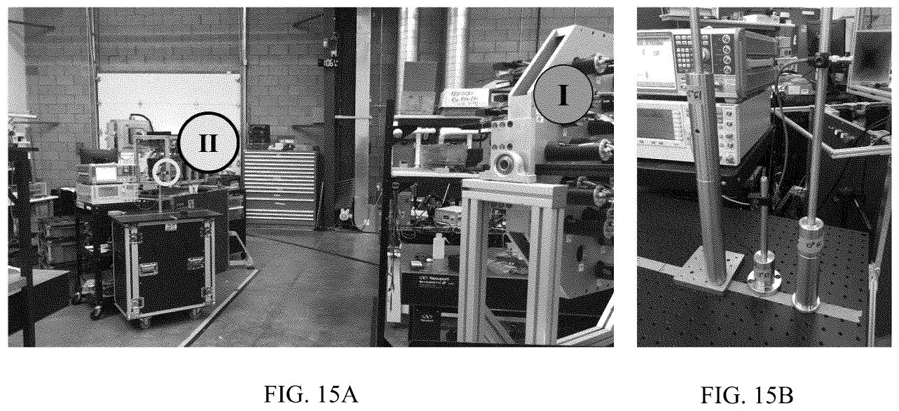

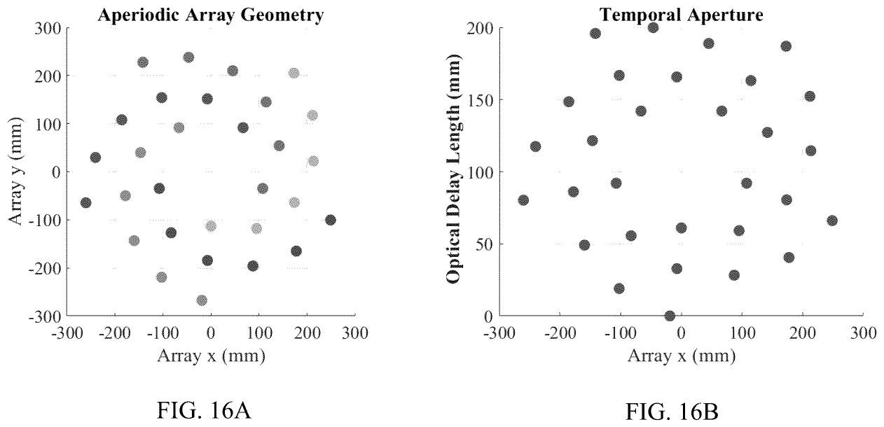

With the approach verified using simulations, an experimental validation is now detailed. While the MATLAB simulations allow for the generation of PSFs corresponding to arbitrary fiber profiles, the prohibitive cost of 30 fiber splitters that would otherwise enable multiple fiber projections in real time restricts the scope of the experimental validation to sequential measurement of PSFs corresponding to a flat and vertical FAWG fiber profile. As a result, an experimental setup in which spatial positioning of RF sources is highly repeatable is necessary. To accomplish this, an optical breadboard was placed on a physically locked platform at a working distance of 4 meters from the antenna array. This arrangement is shown in FIGS. 15A and 15B. RF figures of merit such as FOV and angular resolution are determined by the geometry of the antenna array: as discussed above, the aperiodic arrangement of receiving antenna elements removes grating lobes and distributes side-lobes evenly across the field-of-view in the presence of constraints upon element count and angular resolution. The angular resolution of 0.4° at the upper frequency bound of 40 GHz is determined by the 30 cm diameter of the array and the Rayleigh criterion. The operating field-of-view of this system is determined by the 3 dB beamwidth of the linear tapered slot antennas constituting the array elements, and extends ±5° off broadside in all directions. The spectral resolution is determined in a manner similar to the Rayleigh criterion for the angular resolution: the difference between the longest and shortest optical path length is inversely proportional to the spectral resolution, i.e. as the longest temporal baseline grows the spectral resolution becomes finer. FIGS. 16A and 16B show the spatio-temporal aperture: they illustrate side-by-side depictions of the spatial antenna arrangement, FIG. 16A, and the FAWG fiber lengths plotted versus the horizontal (x-axis) positions of the corresponding antenna elements, FIG. 16B. The similarity of the plots illustrates the direct proportionality of the FAWG time delays to the vertical (y-axis) antenna positions. Note that FIG. 16A is identical to FIG. 13A; it is replicated again for ease of comparison with the temporal aperture of FIG. 16B. For the system herein, the longest temporal baseline is approximately 18 cm in fiber, corresponding to a frequency resolution of approximately 1.5 GHz. The operating bandwidth is primarily defined by the low-noise amplifiers connected to each antenna.

At a distance of 4 m from the antenna array, an increment of one degree is approximately 7 cm in the transverse plane. These markings were measured on an optical breadboard using masking tape for the azimuthal direction, while a set of three antenna stands were fabricated at fixed heights of 0°, 5°, and −3° as shown in FIG. 15B. To place a source at a given spatial position, the desired elevation stand was selected and placed such that the center of the stand base was on top of the azimuthal line. Comparison of PSFs with equivalent source distributions taken at different times demonstrated that this method of source placement was suitably repeatable for the purpose of the experiment. Distributions of pairs of emitters were used for the experiment to demonstrate that multiple sources may be located in k-space; we note that more sources may be included as well at incremental additional computational cost.

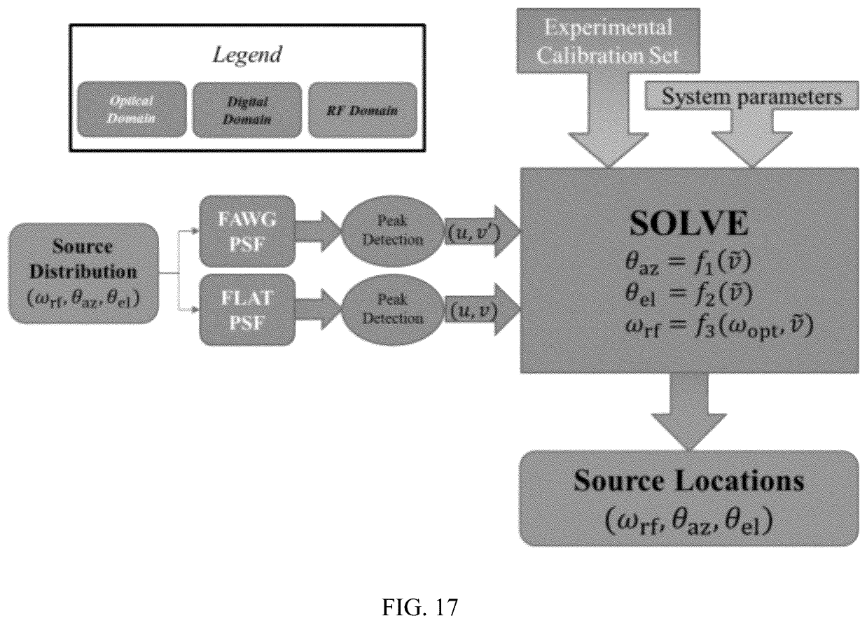

At this stage, with repeatable source placement achieved, the experimental validation of 3D source localization following the diagram shown in FIG. 17 is begun. As discussed, constraints have limited the scope of this work to sequential acquisition of each set of source distributions, first with the FAWG inserted (the resting state of this imaging system), followed by removal of the FAWG and reacquisition of the same set of distributions with a flat fiber profile. While this process incurs a time penalty through the disconnecting and reconnecting of fibers, we note that a network of 1×2 fiber splitters, with one placed at the output of each phase modulator in the front-end, would allow for simultaneous acquisition of two fiber profiles, bringing the localization time down to that necessary to perform peak detection and solve the system of equations, currently a sub-millisecond time scale.

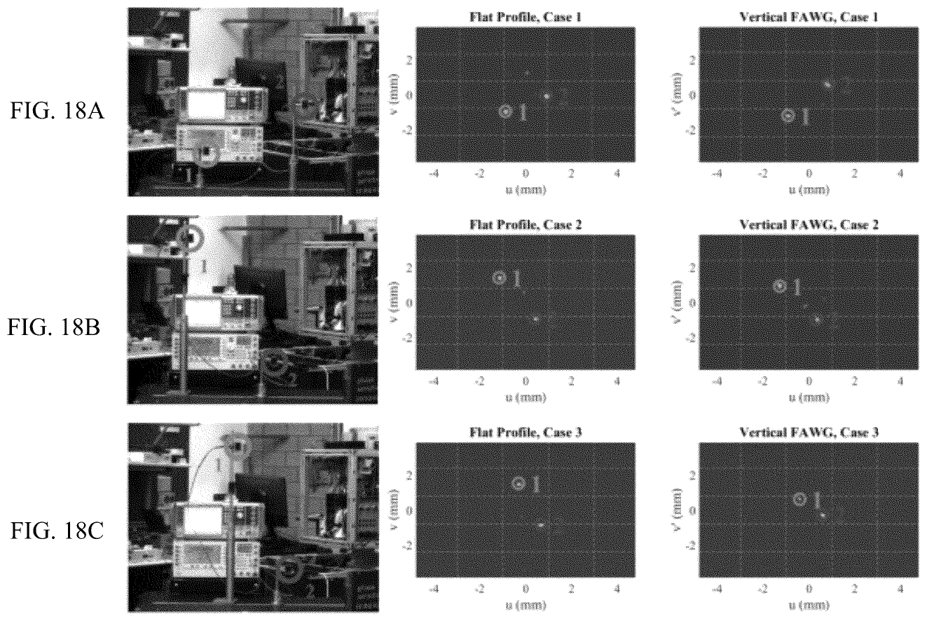

For test cases, true coordinates have been given in triplets, formatted as (ω_{RF1}, α₁, ε₁). Visual images of the three emitter distributions are shown in the left-hand column of FIGS. 18A, 18B, and 18C, while the measured PSFs for the three test cases with both the flat fiber profile as well as the vertically oriented FAWG are shown in the center and right columns of the same figure.

A summary of results is found in Table I. All sources have been reconstructed to on the order of the system resolution: 1.5 GHz spectral and, at finest, 0.4° spatial at 40 GHz as defined by the extent of the RF array. Our results indicate that the approach presented herein does not impede the functionality of the imaging system beyond the choices made through spatio-temporal array design. While the time-multiplexed sequential PSF acquisition (dictated by the prohibitive cost of fiber splitters) was quite lengthy, once the PSFs have been acquired, the time to determine the source locations is on the order of 0.5 ms in MATLAB running on a desktop with 2.5 GHZ Intel Core i5 Processor and 64 GB of RAM. Runtimes for the tomographic approach increase linearly as a function of sources in the scene. In contrast, following peak identification within each PSF the approach presented herein does not necessarily scale with the number of sources, instead simply reconciling which sources are correspondent between PSFs, demonstrating a significant performance increase over existing digital beamforming algorithms. This increase in source reconstruction rate brings spatial-spectral identification to beyond video-rate while the reduction of the source localization problem to a solution of 3 simple equations enables potential development of algorithmic performance improvements specific to this application, with potential for further improvement.

TABLE 2

| | Source 1 | | | | | | Source 2 | | | | | |
|---|---|---|---|---|---|---|---|---|---|---|---|---|
| | True | | | Calculated | | | True | | | Calculated | | |
| Case | f_{rf} | θₐₓ | θₑₗ | f_{rf} | θₐₓ | θₑₗ | f_{rf} | θₐₓ | θₑₗ | f_{rf} | θₐₓ | θₑₗ |
| 1 | 34.0 | −3.0° | −3.0° | 34.0 | −2.8° | −3.0° | 30.0 | 3.0° | 0.0° | 30.5 | 3.1° | −0.3° |
| 2 | 35.0 | −4.0° | 5.0° | 34.6 | −3.5° | 4.3° | 33.0 | 1.0° | −3.0° | 33.2 | 1.3° | −2.9° |
| 3 | 37.0 | −1.0° | 5.0° | 36.5 | −0.9° | 4.3° | 30.0 | 2.0° | −3.0° | 30.7 | 2.2° | −2.9° |

This approach may be improved further through the inclusion of additional time-delay profiles, or perhaps a physically separate antenna array for stereoscopic sensing. However, regardless of the number of spatial arrays used, in order to disambiguate frequency from the combined spatial-spectral information encoded upon k, at least one nonzero time-delay profile must be used. Thus, a minimum of two arrays is required for the approach. Investigations into the use of additional arrays may prove fruitful in the future to further optimize this approach. Efficient optical design may alleviate the marginal cost associated with construction of additional optical processors, which is currently the prohibitive factor associated with adding additional time-delay profiles. Such a future system may harness photonic integrated circuits, a nascent field with the potential to reduce size and power requirements by several orders of magnitude.

The foregoing is illustrative of example embodiments and is not to be construed as limiting thereof. Although some example embodiments have been described, those skilled in the art will readily appreciate that many different implementations and modifications are possible without departing from the novel teachings and advantages of the invention.

What is claimed is:

1. An imaging receiver comprising:
an antenna array including a plurality of antenna elements configured to receive RF signals from at least one RF source;
a plurality of electro-optic modulators corresponding to the plurality of antenna elements, each modulator configured to modulate an optical carrier with a received RF signal to generate modulated optical signals;
a first set of optical fibers respectively coupled to the plurality of antenna elements via the electro-optic modulators and a second set of optical fibers respectively coupled to the plurality of antenna elements via the electro-optic modulators, the first set of optical fibers and the second set of optical fibers configured to transmit the modulated optical signals into an interference region to cause interference among the modulated optical signals to generate optical signal interference;
a lens provided in the interference region and configured to perform a Fourier transform of the optical signal interference to spatial positions on an image plane;
a photodetector array, including a plurality of photodetectors, configured to record the optical signal interference on the image plane; and
a processor configured to computationally reconstruct the at least one RF source in k-space from the recorded optical signal interference,
wherein optical fibers included in the first set of optical fibers have varying lengths, and
wherein optical fibers included in the second set of optical have the same length.

2. The imaging receiver of claim 1, wherein the recorded optical signal interference on the image plane includes spatial information and frequency information.

3. The imaging receiver of claim 1, wherein the corresponding length of each of the optical fibers included in the first set of optical fibers varies incrementally based on the position of the antenna element within the antenna array to which the optical fiber is connected to.

4. The imaging receiver of claim 3, wherein the antenna array is a 1-dimensional array where the plurality of antenna elements are arranged along a first axis.

5. The imaging receiver of claim 4, wherein the plurality of antenna elements are periodically arranged within the 1-dimensional array.

6. The imaging receiver of claim 4, wherein the corresponding length of each of the optical fibers included in the first set of optical fibers incrementally increases with respect to a first direction along the first axis.

7. The imaging receiver of claim 6, further comprising:
a third set of optical fibers respectively coupled to the plurality of antenna elements via the electro-optic modulators, the third set of optical fibers configured to transmit the modulated optical signals into the interference region.

8. The imaging receiver of claim 7, wherein the corresponding length of each of the optical fibers included in the third set of optical fibers vary incrementally based on the position of the antenna element within the antenna array.

9. The imaging receiver of claim 8, wherein the corresponding length of each of the optical fibers included in the third set of optical fibers incrementally increases with respect to a second direction along the first axis, the second direction being opposite to the first direction.

10. The imaging receiver of claim 1, wherein the antenna array is a 2-dimensional array where the plurality of antenna elements are arranged along a first axis and a second axis, the second axis being perpendicular to the first axis.

11. The imaging receiver of claim 10, wherein the plurality of antenna elements are aperiodically arranged within the 2-dimensional array.

12. A method of RF signal processing comprising:
receiving, at an antenna array including a plurality of antenna elements, RF signals from at least one RF source;
modulating the received RF signals from each of the plurality of antenna elements onto an optical carrier to generate modulated optical signals;
transmitting, along a first set of optical fibers and a second set of optical fibers, the modulated optical signals into an interference region to cause interference among the modulated optical signals to generate optical signal interference;
performing a Fourier transform of the optical signal interference to spatial positions on an image plane;
recording the optical signal interference on the image plane using a photodetector array including a plurality of photodetectors; and
reconstructing the at least one RF source in k-space from the recorded optical signal interference,
wherein optical fibers included in the first set of optical fibers have varying lengths, and
wherein optical fibers included in the second set of optical have the same length.

13. The method of claim 12, wherein the recorded optical signal interference on the image plane includes spatial information and frequency information.

14. The method of claim 12, wherein the corresponding length of each of the optical fibers included in the first set of optical fibers varies incrementally based on the position of the antenna element within the antenna array to which the optical fiber is connected to.

15. The method of claim 14, wherein the antenna array is a 1-dimensional array where the plurality of antenna elements are arranged along a first axis.

16. The method of claim 15, wherein the plurality of antenna elements are periodically arranged within the 1-dimensional array.

17. The method of claim 15, wherein the corresponding length of each of the optical fibers included in the first set of optical fibers incrementally increases with respect to a first direction along the first axis.

18. The method of claim 17, further comprising:
transmitting, along a third set of optical fibers, the modulated optical signals into the interference region.

19. The method of claim 18, wherein the corresponding length of each of the optical fibers included in the third set of optical fibers vary incrementally based on the position of the antenna element within the antenna array.

20. The method of claim 19, wherein the corresponding length of each of the optical fibers included in the third set of optical fibers incrementally increases with respect to a second direction along the first axis, the second direction being opposite to the first direction.

21. The method of claim 12, wherein the antenna array is a 2-dimensional array where the plurality of antenna elements are arranged along a first axis and a second axis, the second axis being perpendicular to the first axis.

22. The method of claim 21, wherein the plurality of antenna elements are aperiodically arranged within the 2-dimensional array.
